(19) United States
(12) Patent Application Publication
(10) Pub. No.: US 2025/0024282 A1
(43) Pub. Date: Jan. 16, 2025

(54) ELECTRONIC DEVICE SUPPORTING NON-TERRESTRIAL NETWORK COMMUNICATION AND OPERATION METHOD THEREOF

(71) Applicant: Samsung Electronics Co., LTD., Suwon-si (KR)

(72) Inventors: Hyejeong KIM, Suwon-si (KR); Sohmann KIM, Suwon-si (KR); Hong KIM, Suwon-si (KR)

(73) Assignee: Samsung Electronics Co., LTD., Suwon-si (KR)

(21) Appl. No.: 18/416,544

(22) Filed: Jan. 18, 2024

Related U.S. Application Data
(63) Continuation of application No. PCT/KR24/00629, filed on Jan. 2, 2024.

(30) Foreign Application Priority Data
Jan. 18, 2023 (KR) 10-2023-0007616
Apr. 3, 2023 (KR) 10-2023-0043808

(51) Int. Cl. H04W 24/08; H04W 64/00; H04W 76/30; H04W 84/04; H04W 84/06

(52) U.S. Cl. CPC H04W 24/08; H04W 64/003; H04W 76/30; H04W 84/042; H04W 84/06

(57) ABSTRACT

An electronic device may include: an RF circuit; memory storing instructions; and at least one processor connected to the memory. The at least one processor may be configured to execute the instructions to cause the electronic device to: perform scanning, by using the RF circuit, in a state that the electronic device has not accessed a network; based on a result of the scanning, identify a first cell located around the electronic device; based on identifying that the first cell is associated with satellite communication, monitor whether a trigger requiring a connection to the satellite communication occurs; and based on identifying an occurrence of the trigger, perform at least one first access operation for access to the network based on the first cell.

### CROSS-REFERENCE TO RELATED APPLICATIONS

This application is a bypass continuation application of International Application No. PCT/KR2024/000629, filed on Jan. 12, 2024, which is based on and claims priority to Korean Patent Application No. 10-2023-0007616, filed on Jan. 18, 2023, in the Korean Intellectual Property Office, and Korean Patent Application No. 10-2023-0043808, filed on Apr. 3, 2023, in the Korean Intellectual Property Office, the disclosures of which are incorporated by reference herein in their entireties.

### BACKGROUND

### 1. Field

The disclosure relates to an electronic device for supporting non-terrestrial network communication and an operation method thereof.

### 2. Description of Related Art

In recent years, electronic devices supporting non-terrestrial network communication (e.g., satellite communication) have been actively introduced. As an example, an electronic device may communicate with a satellite of an existing satellite communication company by using a frequency and a communication method of the satellite communication company. As an example, an electronic device may communicate with a satellite based on the long-term evolution (LTE) standard (or 5G standard) by using a cellular frequency according to the LTE standard. As an example, the electronic device may communicate with a satellite based on a 5G non-terrestrial networks (NTN) standard.

For example, in case that an electronic device communicates with a non-terrestrial network based on the LTE standard, some of the frequencies defined by the LTE standard may be allocated for non-terrestrial communication. The electronic device may perform satellite communication by using a protocol stack used for terrestrial communication, and may not require an additional protocol stack for non-terrestrial communication. The electronic device may perform communication without distinguishing between non-terrestrial communication and terrestrial communication. For example, the electronic device may perform cell scanning, camp on a cell that satisfies cell selection criteria, and perform operations to access a network (this may include, for example, camping on, a random access (RA) procedure, a connection establishment procedure, and/or an attach (or, registration) procedure). The electronic device may perform operations for camping on a cell that satisfies the cell selection criteria (and accessing a network), without distinguishing between non-terrestrial and terrestrial communication. Accordingly, the electronic device may prepare to perform non-terrestrial communication in substantially the same manner as for terrestrial communication.

### SUMMARY

According to an aspect of the disclosure, an electronic device may include: an RF circuit; memory storing instructions; and at least one processor connected to the memory. The at least one processor may be configured to execute the instructions to cause the electronic device to: perform scanning, by using the RF circuit, in a state that the electronic device has not accessed a network; based on a result of the scanning, identify a first cell located around the electronic device; based on identifying that the first cell is associated with satellite communication, monitor whether a trigger requiring a connection to the satellite communication occurs; and based on identifying an occurrence of the trigger, perform at least one first access operation for access to the network based on the first cell.

The at least one processor may be configured to execute the instructions to cause the electronic device to, based on failing to identify the occurrence of the trigger, continue monitoring for the trigger while postponing performance of the at least one first access operation.

The at least one processor may be configured to execute the instructions to cause the electronic device to, based on information provided from the first cell, identify whether the first cell is associated with the satellite communication.

The at least one processor may be configured to execute the instructions to cause the electronic device to: after having accessed the first cell, monitor whether a disconnection condition is satisfied; and perform at least one disconnection operation for disconnection from the first cell, based on identifying the disconnection condition.

The at least one processor may be configured to execute the instructions to cause the electronic device to: based on the result of the scanning, identify a second cell located around the electronic device; and based on identifying the second cell as associated with terrestrial communication, perform at least one second access operation for access to the network based on the second cell.

The at least one processor may be configured to execute the instructions to cause the electronic device to identify the first cell as associated with the satellite communication, based on the first cell having a frequency and/or Public Land Mobile Network (PLMN) of the satellite communication.

The at least one processor may be configured to execute the instructions to cause the electronic device to: perform at least one first scan for terrestrial communication; and based on a failure of the at least one first scan, perform at least one second scan for the satellite communication.

The at least one processor may be configured to execute the instructions to cause the electronic device to, after performing the at least one second scan of the first cell associated with the satellite communication, perform at least one third scan for the terrestrial communication before the occurrence of the trigger.

The at least one processor may be configured to execute the instructions to cause the electronic device to: based on identifying a user input causing use of the satellite communication as the occurrence of the trigger, perform the at least one first access operation.

The at least one processor may be configured to execute the instructions to cause the electronic device to: identify a request for use of a first service; and based on identifying that the first service is supported by the satellite communication as the occurrence of the trigger, perform the at least one first access operation.

The at least one processor may be configured to execute the instructions to cause the electronic device to: after scanning the first cell associated with the satellite communication, and before the occurrence of the trigger, camp on and access the first cell, based on detection of another trigger for receiving a message; receive or wait for the message for which the electronic device is a recipient; and disconnect from the first cell after the receiving or waiting for the message.

According to an aspect of the disclosure, an operation method of an electronic device, may include: performing scanning in a state that the electronic device has not accessed a network; based on a result of the scanning, identifying a first cell located around the electronic device; based on identifying that the first cell is associated with satellite communication, monitoring whether a trigger requiring a connection to the satellite communication occurs; and based on identifying an occurrence of the trigger, performing at least one first access operation for access to the network based on the first cell.

The operation method may include: based on failing to identify the occurrence of the trigger, continuing monitoring for the trigger while postponing performance of the at least one first access operation.

The operation method may include: based on information provided from the first cell, identifying whether the first cell is associated with the satellite communication.

The operation method may include: after having accessed the first cell, monitoring whether a disconnection condition is satisfied; and performing at least one disconnection operation for disconnection from the first cell, based on identifying the disconnection condition.

The operation method may include: based on the result of the scanning, identifying a second cell located around the electronic device; and based on identifying the second cell as associated with terrestrial communication, performing at least one second access operation for access to the network based on the second cell.

The operation method may include: identifying the first cell as associated with the satellite communication, based on the first cell having a frequency and/or Public Land Mobile Network (PLMN) of the satellite communication.

The operation method may include: performing at least one first scan for terrestrial communication; and based on a failure of the at least one first scan, performing at least one second scan for the satellite communication.

The operation method may include: after scanning the first cell associated with the satellite communication, and before the occurrence of the trigger, camping on and accessing the first cell based on detection of another trigger for receiving a message; receiving or waiting for the message for which the electronic device is a recipient; and after the receiving or waiting for the message, disconnecting from the first cell.

According to an aspect of the disclosure, a non-transitory computer readable medium may store instructions configured to, when executed by at least one processor of an electronic device, cause the electronic device to: perform scanning in a state that the electronic device has not accessed a network; based on a result of the scanning, identify a first cell located around the electronic device; based on identifying that the first cell is associated with satellite communication, monitor whether a trigger requiring a connection to the satellite communication occurs; and based on identifying an occurrence of the trigger, perform at least one first access operation for access to the network based on the first cell.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device in a network environment according to an embodiment;

FIG. 2A is a block diagram of an electronic device for supporting legacy network communication and 5G network communication according to an embodiment;

FIG. 2B is a block diagram of an electronic device for supporting legacy network communication and 5G network communication according to an embodiment;

FIG. 3 illustrates access of an electronic device according to an embodiment;

FIG. 4A illustrates a satellite communication system according to an embodiment;

FIG. 4B illustrates a satellite communication system according to an embodiment;

FIG. 5A is a flowchart illustrating an operation method of an electronic device according to an embodiment;

FIG. 5B is a flowchart illustrating an operation method of an electronic device according to an embodiment;

FIG. 6A is a flowchart illustrating an operation method of an electronic device according to an embodiment;

FIG. 6B illustrates scanning of an electronic device according to an embodiment;

FIG. 6C is a flowchart illustrating an operation method of an electronic device according to an embodiment;

FIG. 7 is a flowchart illustrating an operation method of an electronic device according to an embodiment;

FIG. 8A is a flowchart illustrating an operation method of an electronic device according to an embodiment;

FIG. 8B is a flowchart illustrating an operation method of an electronic device according to an embodiment;

FIG. 9A is a flowchart illustrating an operation method of an electronic device according to an embodiment;

FIG. 9B illustrates a screen displayed on an electronic device according to an embodiment;

FIG. 10 is a flowchart illustrating an operation method of an electronic device according to an embodiment;

FIG. 11A is a flowchart illustrating an operation method of an electronic device according to an embodiment;

FIG. 11B illustrates a screen displayed on an electronic device according to an embodiment;

FIG. 11C illustrates a screen displayed on an electronic device according to an embodiment;

FIG. 12 is a flowchart illustrating an operation method of a processor and a communication processor according to an embodiment;

FIG. 13 is a flowchart illustrating an operation method of an electronic device according to an embodiment;

FIG. 14 is a flowchart illustrating an operation method of an electronic device according to an embodiment; and

FIG. 15 is a flowchart illustrating an operation method of an electronic device according to an embodiment.

### DETAILED DESCRIPTION

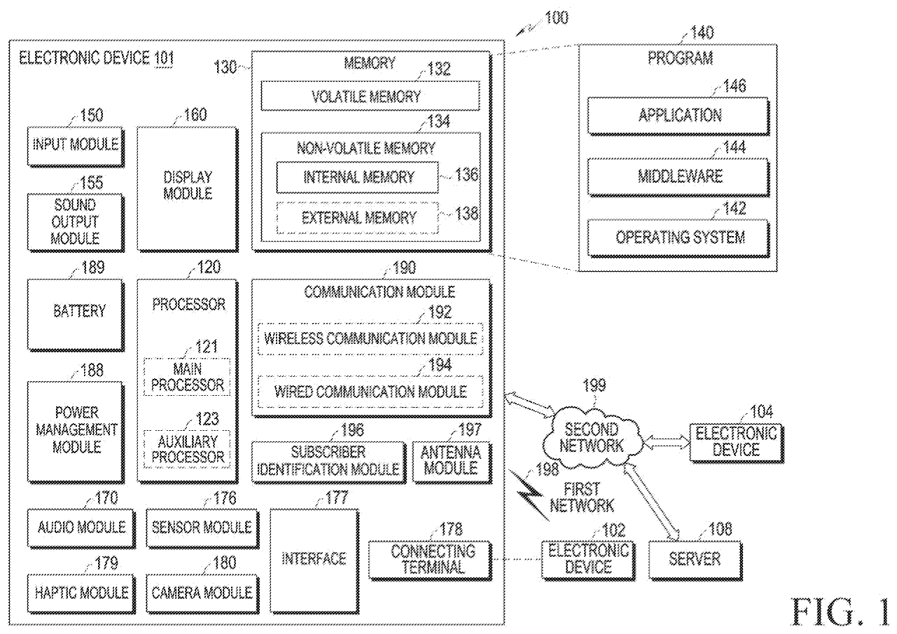

FIG. 1 is a block diagram illustrating an electronic device 101 in a network environment 100 according to embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

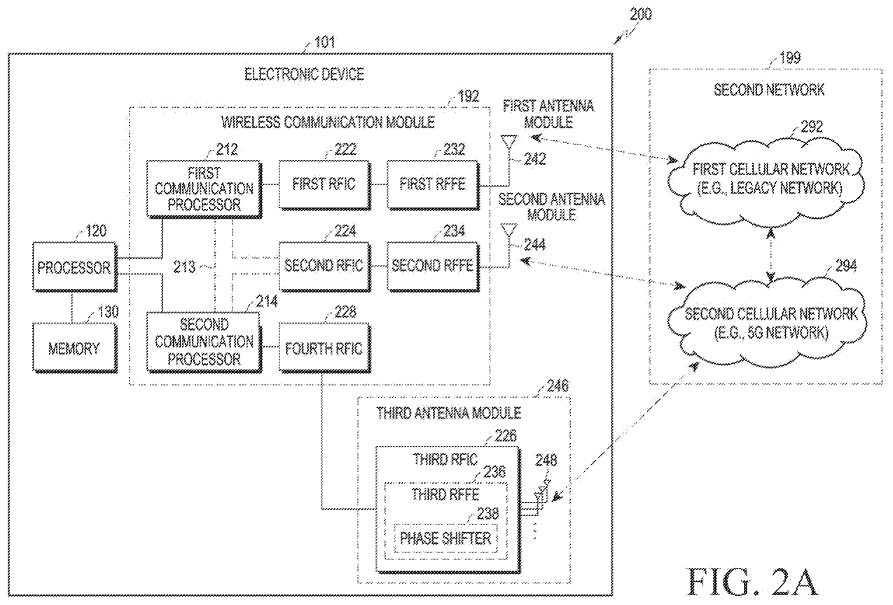

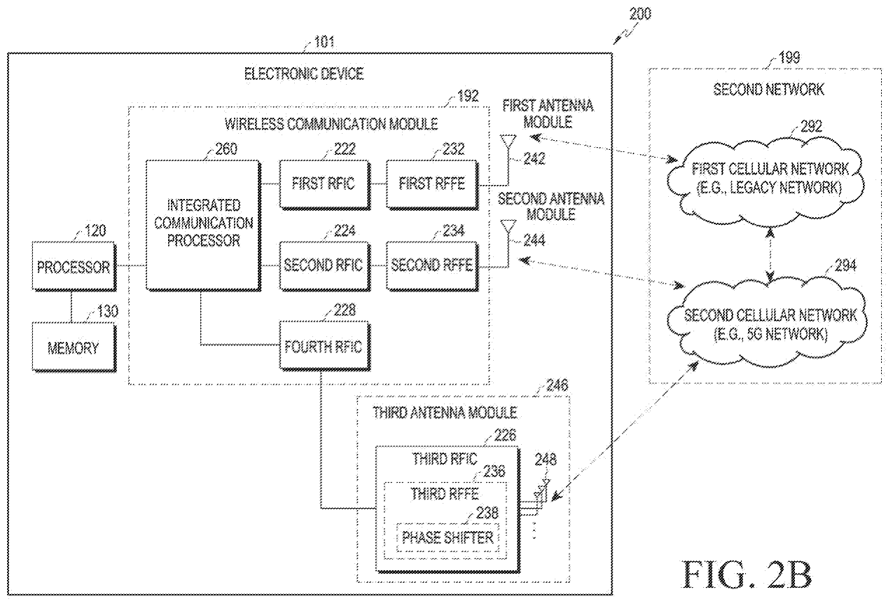

FIG. 2A illustrates a block diagram 200 of an electronic device 101 for supporting legacy network communication and 5G network communication according to an embodiment. Referring to FIG. 2, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 246, and antennas 248. The electronic device 101 may further include at least one processor 120 and at least one memory 130. A second network 199 may include a first cellular network 292 and a second cellular network 294. According to another embodiment, the electronic device 101 may further include at least one component among the components illustrated in FIG. 1, and the second network 199 may further include at least one different network. According to an embodiment, the first communication processor 212, the second communication processor 214, the first RFIC 222, the second RFIC 224, the fourth RFIC 228, the first RFFE 232, and the second RFFE 234 may form at least a part of a wireless communication module 192. According to another embodiment, the fourth RFIC 228 may be omitted or included as a part of the third RFIC 226.

The first communication processor 212 may support establishment of a communication channel in a band to be used for wireless communication with a first cellular network 292, and legacy network communication through the established communication channel. According to an embodiment, the first cellular network may be a legacy network including a 2nd generation (2G), 3G, 4G, or long term evolution (LTE) network. The second communication processor 214 may support establishment of a communication channel corresponding to a designated band (e.g., about 6 GHz to about 60 GHz) among bands to be used for wireless communication with a second cellular network 294, and 5G network communication through the established communication channel. According to an embodiment, the second cellular network 294 may be a 5G network defined by 3GPP. Additionally, according to an embodiment, the first communication processor 212 or the second communication processor 214 may support establishment of a communication channel corresponding to another designated band (e.g., about 6 GHz or lower) among the bands to be used for wireless communication with the second cellular network 294, and 5G network communication through the established communication channel.

The first communication processor 212 may transmit or receive data to or from the second communication processor 214. For example, data classified as transmittable through the second cellular network 294 may be changed to be transmitted through the first cellular network 292. In this case, the first communication processor 212 may receive transmission data from the second communication processor 214. For example, the first communication processor 212 may transmit or receive data through the second communication processor 214 and an inter-processor interface 213. The inter-processor interface 213 may be implemented as, for example, a universal asynchronous receiver/transmitter (UART) (e.g., HS-high speed-UART (HS-UART) or a peripheral component interconnect bus express (PCIe) interface), but there are no restrictions on the type thereof. Alternatively, the first communication processor 212 and the second communication processor 214 may exchange control information and packet data information by using, for example, shared memory. The first communication processor 212 may transmit or receive various types of information such as sensing information, information on output strength, and resource block (RB) allocation information to or from the second communication processor 214.

Depending on the implementation, the first communications processor 212 may not be directly connected to the second communications processor 214. In this case, the first communication processor 212 may transmit or receive data to or from the second communication processor 214 through the processor 120 (e.g., an application processor). For example, the first communication processor 212 and the second communication processor 214 may transmit or receive data to or from the processor 120 (e.g., an application processor) through the HS-UART interface or PCIe interface, but there are no restrictions on the type of interface. Alternatively, the first communication processor 212 and the second communication processor 214 may exchange control information and packet data information by using shared memory with the processor 120 (e.g., an application processor).

According to an embodiment, the first communication processor 212 and the second communication processor 214 may be implemented within a single chip or a single package. According to an embodiment, the first communication processor 212 or the second communication processor 214 may be formed within a single chip or a single package with the processor 120, the auxiliary processor 123, or the communication module 190. For example, as shown in FIG. 2B, the integrated communication processor 260 may support functions for communication with both the first cellular network 292 and the second cellular network 294.

As described above, at least one of the processor 120, the first communication processor 212, the second communication processor 214, or the integrated communication processor 260 may be implemented as a single chip or a single package. In this case, a single chip or a single package may include memory (or storage measure) for storing instructions that cause performance of at least some of operations performed according to embodiments, and a processing circuit for executing instructions (or, there are no restrictions on the name, such as an operation circuit).

In the case of transmitting a signal, the first RFIC 222 may convert a baseband signal generated by the first communication processor 212 into a radio frequency (RF) signal of approximately 700 MHz to approximately 3 GHz that is used in the first cellular network 292 (e.g., a legacy network). In the case of receiving a signal, an RF signal may be obtained from the first cellular network 292 (e.g., a legacy network) through an antenna (e.g., the first antenna module 242) and may be pre-processed through an RFFE (e.g., the first RFFE 232). The first RFIC 222 may convert the preprocessed RF signal into a baseband signal so as to be processed by the first communication processor 212.

In the case of transmitting a signal, the second RFIC 224 may convert a baseband signal generated by the first communication processor 212 or the second communication processor 214 into an RF signal (hereinafter referred to as a “5G Sub6 RF signal”) in a Sub6 band (e.g., approximately 6 GHz or lower) used in the second cellular network 294 (e.g., a 5G network). In the case of receiving a signal, a 5G Sub6 RF signal may be obtained from the second cellular network 294 (e.g., a 5G network) through an antenna (e.g., the second antenna module 244) and may be pre-processed through an RFFE (e.g., the second RFFE 234). The second RFIC 224 may convert the pre-processed 5G Sub6 RF signal into a baseband signal so as to be processed by a corresponding communication processor of the first communication processor 212 or the second communication processor 214.

The third RFIC 226 may convert a baseband signal generated by the second communication processor 214 into an RF signal (hereinafter referred to as a “5G Above6 RF signal”) in a 5G Above6 band (e.g., approximately 6 GHz to approximately 60 GHz) to be used in the second cellular network 294 (e.g., a 5G network). In the case of receiving a signal, a 5G Above6 RF signal may be obtained from the second cellular network 294 (e.g., a 5G network) through an antenna (e.g., the antenna 248) and may be pre-processed through a third RFFE 236. The third RFIC 226 may convert the preprocessed 5G Above6 RF signal to a baseband signal so as to be processed by the second communication processor 214. According to an embodiment, the third RFFE 236 may be formed as a part of the third RFIC 226.

According to an embodiment, the electronic device 101 may include the fourth RFIC 228 independently of the third RFIC 226 or as at least part of the third RFIC 226. In this case, the fourth RFIC 228 may convert a baseband signal generated by the second communication processor 214 into an RF signal (hereinafter referred to as an “IF signal”) of an intermediate frequency band (e.g., approximately 9 GHz to approximately 11 GHZ) and then transfer the IF signal to the third RFIC 226. The third RFIC 226 may convert the IF signal into a 5G Above6 RF signal. In the case of receiving a signal, a 5G Above6 RF signal may be received from the second cellular network 294 (e.g., a 5G network) through an antenna (e.g., the antenna 248) and may be converted into an IF signal by the third RFIC 226. The fourth RFIC 228 may convert the IF signal into a baseband signal to be processed by the second communication processor 214.

According to an embodiment, the first RFIC 222 and the second RFIC 224 may be implemented with at least part of a single chip or a single package. According to an embodiment, in case that the first RFIC 222 and the second RFIC 224 in FIG. 2A or FIG. 2B are implemented in a single chip or a single package, they may be implemented as an integrated RFIC. In this case, the integrated RFIC may be connected to the first RFFE 232 and the second RFFE 234 to convert a baseband signal into a signal in a band supported by the first RFFE 232 and/or the second RFFE 234, and to transmit the converted signal to one of the first RFFE 232 and the second RFFE 234. According to an embodiment, the first RFFE 232 and the second RFFE 234 may be implemented as at least part of a single chip or a single package. According to an embodiment, at least one antenna module of the first antenna module 242 or the second antenna module 244 may be omitted or combined with another antenna module to process RF signals in a corresponding plurality of bands.

According to an embodiment, the third RFIC 226 and the antenna 248 may be disposed on the same substrate to form a third antenna module 246. For example, the wireless communication module 192 or the processor 120 may be disposed on a first substrate (e.g., a main PCB). In this case, the third antenna module 246 may be formed by disposing the third RFIC 226 on a partial region (e.g., on a lower surface) of a second substrate (e.g., a sub PCB) separated from the first substrate and by disposing the antenna 248 in another partial region (e.g., on an upper surface) of the second substrate. As the third RFIC 226 and the antenna 248 are disposed on the same substrate, it may be possible to decrease a length of a transmission line between the third RFIC 226 and the antenna 248. For example, the decrease in the transmission line may make it possible to prevent a signal in a high-frequency band (e.g., approximately 6 GHz to approximately 60 GHz) used for the 5G network communication from being lost (or attenuated) due to the transmission line. Accordingly, the electronic device 101 may improve the quality or speed of communication with the second cellular network 294 (e.g., 5G network).

According to an embodiment, the antenna 248 may be formed as an antenna array including a plurality of antenna elements that may be used for beamforming. In this case, the third RFIC 226 may include a plurality of phase shifters 238 corresponding to the plurality of antenna elements, for example, as part of the third RFFE 236. During transmission, the plurality of phase shifters 238 may convert the phase of a 5G Above6 RF signal to be transmitted to the outside (e.g., a base station of a 5G network) of the electronic device 101 through respective corresponding antenna elements. Upon reception, the plurality of phase converters 238 may convert the phase of a 5G Above6 RF signal received from the outside through respective corresponding antenna elements into the same or substantially the same phase. Accordingly, transmission or reception is possible through beamforming between the electronic device 101 and the outside.

The second cellular network 294 (e.g., the 5G network) may operate independently of the first cellular network 292 (e.g., the legacy network) (e.g., standalone (SA)), or may operate in conjunction therewith (e.g., non-standalone (NSA)). For example, the 5G network may have only an access network (e.g., a 5G radio access network (RAN) or next generation RAN (NG RAN)), and may not have a core network (e.g., a next generation core (NGC)). In this case, the electronic device 101 may access the access network of the 5G network and then may access an external network (e.g., the Internet) under the control of a core network (e.g., an evolved packed core (EPC)) of the legacy network. Protocol information for communication with the legacy network (e.g., LTE protocol information) or protocol information for communication with the 5G network (e.g., new radio (NR) protocol information) may be stored in the memory 130 and accessed by other components (e.g., the processor 120, the first communication processor 212, or the second communication processor 214).

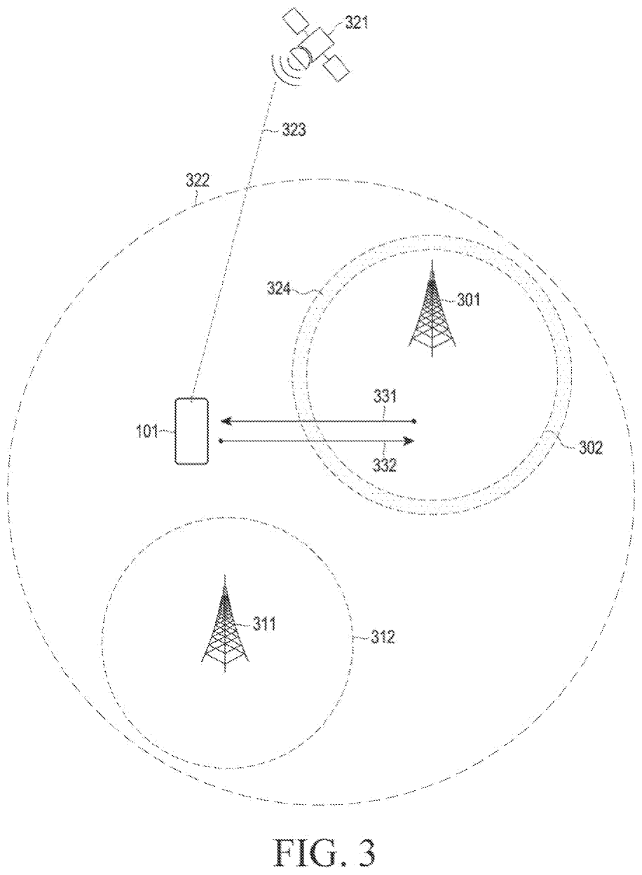

FIG. 3 illustrates access of an electronic device according to an embodiment.

According to an embodiment, the electronic device 101 may be located within a coverage area 322 of a satellite 321. However, it will be understood by those skilled in the art that satellite 321 may be replaced by any other type of electronic device that supports non-terrestrial communication. The electronic device 101 may access the satellite 321 within the coverage area 322 of the satellite 321 (indicated by reference numeral 323). For example, the electronic device 101 may perform cell scanning within the coverage area 322 of the satellite 321. As a result of the performing of cell scanning, the electronic device 101 may identify the satellite 321 (or, alternatively, named as a cell corresponding to the satellite 321). In case that the satellite 321 satisfies the cell selection criteria, the electronic device 101 may camp on the satellite 321. The electronic device 101 may camp on the satellite 321 and perform at least one operation to establish a connection (e.g., a radio resource control (RRC) connection) with the satellite 321. The electronic device 101 may perform access to a network. Network access may include performing at least one operation of, for example, attaching to (or registration to) a core network (e.g., MME or AMF) corresponding to the satellite 321 based on the established connection. Network access may include, for example, preceding operations for attaching to the core network (e.g., camping on, an RA procedure, and/or a connection establishment procedure). Accordingly, the access 323 to the satellite 321 may include camping on, establishing a connection, and/or attaching, but is not limited thereto. Further, disconnecting may include detaching from a network, connection release, and/or declaring an RLF, but is not limited thereto. The coverage 322 of the satellite communication may be relatively large (e.g., more than 50 times larger) compared to coverages 302 and 312 by terrestrial base stations 301 and 311. The coverage 322 based on satellite communication may cover areas that are not covered, for example, by the coverages 302 and 312 based on terrestrial communication, thereby allowing users to communicate using the electronic device 101 even in areas where terrestrial communication is not supported.

For example, satellite communication based on the satellite 321 may have limited frequency resources and/or support limited services. For example, satellite communication may provide limited services, such as an emergency service (e.g., an emergency call) and/or short message service (SMS), while not supporting other general services for data transmission and reception (e.g., video streaming, but not limited thereto). Satellite communication may support limited bandwidth (e.g., 1.4 MHz) compared to terrestrial communication. For example, satellite communication may have a relatively low overall cell capacity of 2 to 4 Mbps, even when supporting voice calling and/or data services. On the other hand, terrestrial communication may support bandwidths of up to 100 MHz, for example, in the case of carrier aggregation (CA) being enabled, and cell capacity may also exceed 1 Gbps.

Since satellite communication may require higher costs and/or provide limited services compared to terrestrial communication, terminals including electronic device 101 are desirable to use terrestrial communication. For example, even after the electronic device 101 has accessed the satellite 321 (indicated by reference numeral 323), in case that terrestrial base stations 301 and 311 are detected, it may be desirable to access the terrestrial base stations 301 and 311. For example, in case that the electronic device 101 is located in a boundary region 324, or in case that the electronic device 101 is traveling (indicated by reference numerals 331 and 332), the electronic device 101 is likely to frequently re-access satellite communication and terrestrial communication alternately. In case that satellite communication is defined by a Public Land Mobile Network (PLMN) different from that of terrestrial communication, the electronic device 101 may repeat accessing a new cell when the electronic device is located in the boundary region 324 or is traveling (indicated by reference numerals 331 and 332). In case that satellite communication and terrestrial communication are defined by the same PLMN, the electronic device 101 does not distinguish between satellite communication and terrestrial communication, and thus there is a possibility that the electronic device 101 accesses the satellite 321 in an area where terrestrial communication occurs in a weak electric field. Furthermore, as the location of a cell changes while terminals accessing satellite communication are in an idle state, there is a possibility that tracking area update (TAU) may be performed repeatedly. In particular, the signaling overhead rate for satellite communication (e.g., 20%) may be greater than the signaling overhead rate for terrestrial communication (e.g., 2%), and frequent access to satellite communication may be undesirable. For example, the bandwidth for satellite communication may be 1.4 MHz, which may be less than the bandwidth for terrestrial communication of 20 MHz (or more), and thus a signaling overhead ratio for satellite communication may be greater than a signaling overhead ratio for terrestrial communication. Furthermore, despite the fact that satellite communication provides only limited services, there is a possibility that the electronic device 101 may repeatedly access the satellite 321 and receive rejections relating thereto even in the case of attempting services that are not supported by the satellite communication. For example, in case that only emergency services and SMS are supported by the satellite communication, if the electronic device 101 identifies a trigger for data communication, the electronic device may transmit a packet data network (PDN) connection establishment request and receive a reject from a network in response thereto. Since the electronic device 101 is unable to identify the cause of the rejection, the electronic device may continue to transmit the PDN connection establishment request, thereby potentially wasting resources of the satellite communication. Furthermore, in case that a large number of terminals exist in the coverage area 322 of the satellite 321, there is a possibility that terminals exceeding the number of connected UEs that can be managed by the satellite 321 may request access. The electronic device 101 according to an embodiment may be configured to, even in case that the satellite 321 is scanned, perform at least part of at least one operation for access to the network, based on identification of a designated trigger, rather than immediately performing at least part of the at least one operation for access to the network. Accordingly, a relatively large number of terminals may be prevented from accessing the satellite communication for the satellite 321, and the electronic device 101 may access the satellite 321, for example, when a specified condition is satisfied (which may correspond to, for example, a case in which a service supported by the satellite communication is requested, but is not limited thereto).

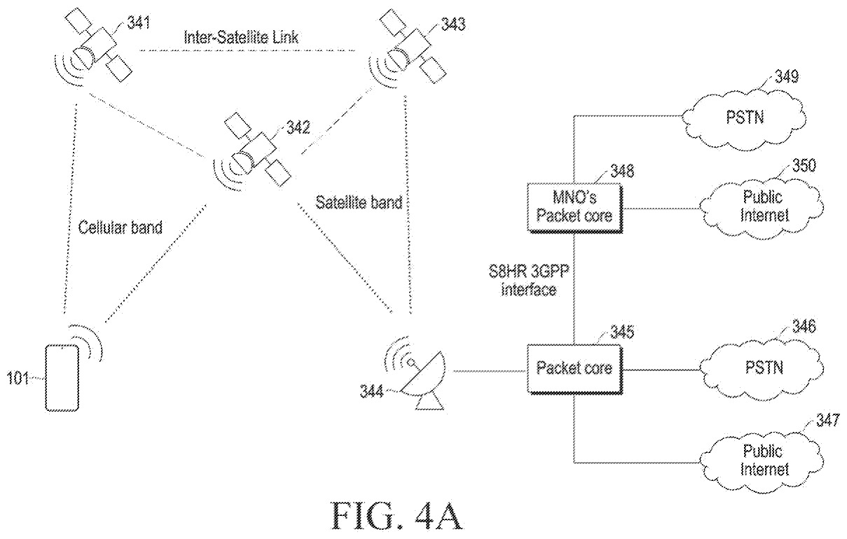

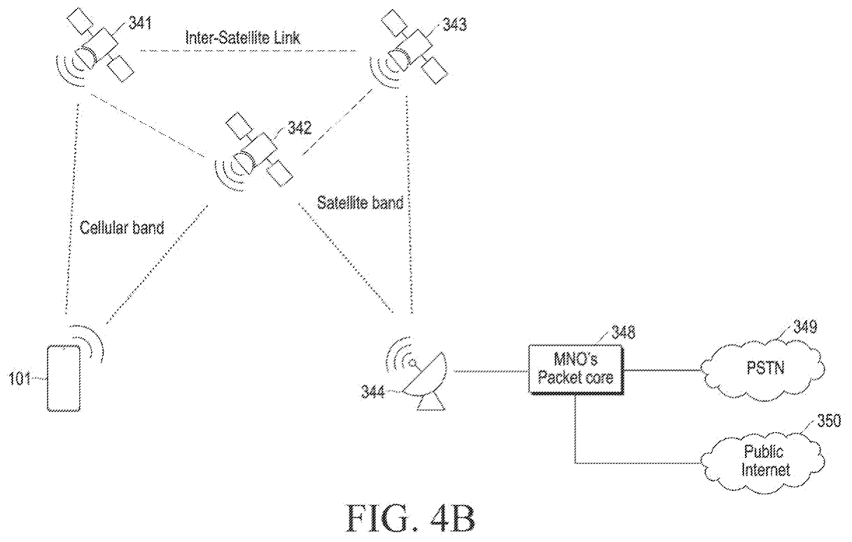

FIG. 4A illustrates a satellite communication system according to an embodiment.

Referring to FIG. 4A, a satellite communication provider may operate satellites 341, 342, and 343. The satellites 341, 342, and 343 may be mobile and/or geostationary satellites, and are not limited to the type thereof. The satellites 341, 342, and 343 may communicate with the electronic device 101, for example, using a cellular band. The cellular band may be, for example, operating bands supported by existing E-UTRAs and/or NRs, but not limited thereto. The satellites 341, 342, and 343 may communicate with a radio unit 344, which is operated by a satellite communication provider, by using a satellite band. The satellite band may be different from the cellular band, but in some cases may be configured to be the same. The satellites 341, 342, and 343 may be implemented in a regenerative manner, for example. The satellites 341, 342, and 343 may include (or be implemented as) a base station (e.g., eNode B), for example, if the satellites 341, 342, and 343 are implemented in a regenerative scheme. The satellites 341, 342, and 343 may be implemented in a bent-pipe scheme, for example. In case that the satellites 341, 342, and 343 are implemented in a bent-pipe scheme, the frequency band of signals received from the electronic device 101 may be converted to match the reception band of the terrestrial station, and the same signals may be amplified and retransmitted to the radio unit 344 of the terrestrial station. The satellites 341, 342, and 343 of bent-pipe scheme may perform a role such as a repeater and, for example, may change, amplify, and/or filter an analog signal.

A packet core 345 of the satellite communication provider may transmit and receive data corresponding to the electronic device 101 via the radio unit 344. Accordingly, the electronic device 101 may transmit and receive data via a public switched telephone network (PSTN) 346 and/or a public Internet 347. Alternatively, the packet core 345 may relay data to a packet core 348 of a mobile network operator (MNO) via an interface (e.g., an S8HR 3GPP interface, but not limited thereto). Accordingly, the electronic device 101 may transmit and receive data to and from a PSTN 349 and/or a public Internet 350 via the packet core 348 of the mobile network operator. As an example, the satellites 341, 342, and 343 may be operated by a mobile network operator, as shown in FIG. 4B. In this case, the electronic device 101 may transmit and receive data to and from the PSTN 349 and/or the public Internet 350 via the packet core 348 of mobile network operator, as shown in FIG. 4B, without relaying the packet core 345 by the satellite communication provider.

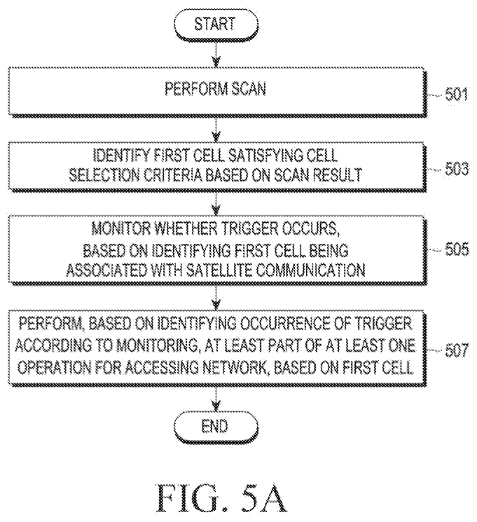

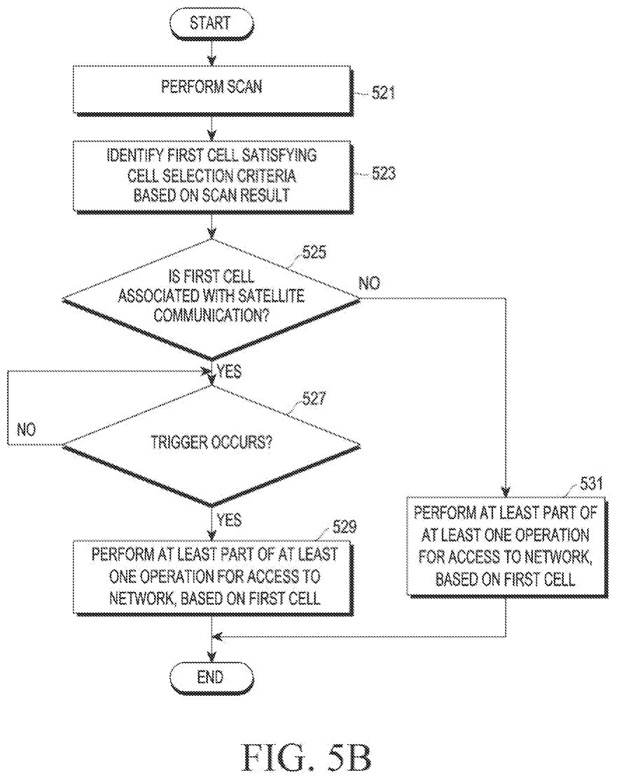

FIG. 5A is a flowchart illustrating an operation method of an electronic device according to an embodiment.

According to an embodiment, the electronic device 101 (e.g., the processor 120, the first communication processor 212, the second communication processor 214, and/or the integrated communication processor 260) may perform scanning in operation 501. As an example, the electronic device 101 may perform scanning based on stored information (which may be named, for example, a stored scan), but the type of scanning is not limited. For example, the electronic device 101 may preferentially perform scanning for terrestrial communication than for satellite communication. However, this is an example and there are no limitations on the priorities, and scanning based on the priorities will be described later. In operation 503, the electronic device 101 may identify a first cell that satisfies the cell selection criteria based on a result of the scanning. For example, the electronic device 101 may identify that the cell selection criteria is satisfied in case that Srxlev is greater than 0 and Squal is greater than 0. The Srxlev and Squal may be defined in accordance with third generation partnership project (3GPP) technical specification (TS) 36.331 or 38.331.

According to an embodiment, the electronic device 101 may monitor whether a trigger for satellite communication has occurred, based on identifying that the first cell is associated with satellite communication, in operation 505. In contrast to performing at least one operation for access to the network (e.g., camping on, a random access procedure, establishing an RRC connection, and/or attaching to the network) immediately after a cell satisfying the cell selection criteria is identified, the electronic device 101 according to an embodiment may monitor whether a trigger for satellite communication occurs without immediately performing at least part of the at least one operation for access to the network after a cell satisfying the cell selection criteria is identified. For example, the electronic device 101 may suspend performing at least part of the at least one operation for access to the network, based on the cell corresponding to the satellite communication. In at least one example, the electronic device 101 may suspend camping on a first cell that has satisfied a cell selection criteria and monitor whether a trigger occurs. In this case, for example, if the occurrence of the trigger is identified, the electronic device 101 may perform camping on, a RA procedure, establishment of RRC connection, and/or accessing the network. For example, a state in which the electronic device 101 is suspending camp-on may be referred to as the electronic device 101 being in a pre-camp on state. In at least one example, the electronic device 101 may camp on a first cell that has satisfied a cell selection criteria, and suspend subsequent operations (e.g., a random access procedure, establishing an RRC connection, and/or attaching to the network), and may monitor whether a trigger has occurred. In this case, for example, if it is identified that a trigger has occurred, the electronic device 101 may perform a post-camp-on operation (e.g., RA procedure, establishment of an RRC connection, and/or attach to a network). However, those skilled in the art will understand that the suspended operations are not limited. The electronic device 101 may identify, for example, whether the first cell is associated with satellite communication based on a PLMN and/or frequency (e.g., may be ARFCN, but is not limited thereto) for the first cell. For example, the electronic device 101 may store information about the PLMN associated with satellite communication. For example, the electronic device 101 may store information capable of identifying whether communication is satellite communication at the time of manufacture (e.g., it may be, but is not limited thereto, a PLMN corresponding to the satellite communication and/or an ARFCN corresponding to the satellite communication). For example, the electronic device 101 may receive and store information identifying whether a communication is a satellite communication from a server operated by a satellite communication provider and/or a communication network operator. The electronic device 101 may identify whether the first cell is associated with satellite communication based, for example, on whether the PLMN and/or frequency identified as a result of the scanning is the same as the pre-stored information capable of identifying whether the communication is a satellite communication, but this is an example and the manner of identification is not limited thereto. For example, the electronic device 101 may receive information capable of identifying whether the first cell is associated with satellite communication based on information received from a base station (e.g., a satellite) (e.g., a system information block, which may be, but is not limited thereto, SIB1). For example, the electronic device 101 may identify, based on the information received from the base station, whether the cell is associated with satellite communication, but this is an example and there is no limitation on how the identification may be made.

According to an embodiment, the electronic device 101 may perform at least one operation for access to the network, based on the first cell, based on that the occurrence of trigger has been identified according to monitoring, in operation 507. As described above, in at least one example, upon identifying that a trigger has occurred, the electronic device 101 may perform a camp-on, perform an RA procedure, establish an RRC connection, and/or access the network. In at least one example, the electronic device 101 may camp-on a first cell that has satisfied the cell selection criteria, and may suspend subsequent operations (e.g., RA procedures, establishment of an RRC connection, and/or attachment to the network) and monitor for the occurrence of a trigger. Further, upon identifying that a trigger has occurred, the electronic device 101 may perform post-camp-on operations (e.g., RA procedures, establishment of an RRC connection, and/or attachment to the network), and there is no limitation on the time of the monitoring of the trigger as described above.

For example, the trigger may be a user input for using satellite communication. For example, a trigger may be an event associated with the utilization of a service (e.g., emergency services, SMS, calls, and/or data communication, but not limited thereto). The types of triggers are not limited and will be discussed later. Thereafter, the electronic device 101 may perform at least part of the at least one operation for access to the network (e.g., camping on, at least one operation for RA procedures, at least one operation for establishing an RRC connection, and/or at least one operation for attaching). As described above, by not performing at least part of the at least one operation for access to the network immediately when the satellite communication is scanned, but by performing at least part of the at least one operation for access to the network, based on the occurrence of a trigger associated with utilization of the satellite communication and/or a service supported by the satellite communication, the electronic device 101 may prevent a relatively large number of terminals from accessing the satellite communication, thereby conserving relatively limited satellite communication resources.

FIG. 5B is a flowchart illustrating an operation method of an electronic device according to an embodiment.

According to an embodiment, the electronic device 101 (e.g., the processor 120, the first communication processor 212, the second communication processor 214, and/or the integrated communication processor 260) may perform scanning in operation 521. For example, the electronic device 101 may perform scanning based on stored information. For example, the electronic device 101 may preferentially perform scanning for terrestrial communication than for satellite communication. However, this is an example and there are no limitations on the priorities, and scanning based on the priorities will be described later. In operation 523, the electronic device 101 may identify a first cell that satisfies the cell selection criteria based on a result of the scanning. In operation 525, the electronic device 101 may identify whether the first cell is associated with satellite communication. As described above, the electronic device 101 may identify whether the first cell is associated with satellite communication based on a comparison of pre-stored information (e.g., PLMN and/or frequency corresponding to the satellite communication) capable of identifying whether communication is satellite communication, and information (e.g., scanned PLMN and/or scanned frequency) identified based on a result of the scanning. Alternatively, the electronic device 101 may identify, based on information from the first cell (e.g., system information, which may be, but is not limited thereto, SIB1), whether the first cell is associated with satellite communication. In case that the first cell is not associated with satellite communication (e.g., the first cell is associated with terrestrial communication) (“no” in operation 525), the electronic device 101 may perform at least part of the at least one operation for access to the network, based on the first cell, in operation 531. In case that the first cell is associated with satellite communication (“yes” in operation 525), the electronic device 101 may monitor whether a trigger has occurred, in operation 527. In case that, as a result of the monitoring, a trigger has not occurred (“no” in operation 527), the electronic device 101 may continue to perform the monitoring. In case that a trigger has occurred as a result of the monitoring (“yes” in operation 527), the electronic device 101 may perform at least part of the at least one operation for access to the network, based on the first cell in operation 529. As described above, the electronic device 101 may suspend performing at least part of the at least one operation for access to the network (despite satisfaction of the cell selection criteria), and then perform at least part of the at least one operation for access to the network based on the first cell (associated with satellite communication), based on identification of the occurrence of the trigger. As described above, in at least one example, upon identifying that the trigger has occurred, the electronic device 101 may perform a camp-on, perform RA procedures, establish an RRC connection, and/or attach to the network. In at least one example, the electronic device 101 may camp-on the first cell that has satisfied the cell selection criteria, suspend subsequent operations (e.g., RA procedure, establishment of RRC association, and/or attachment to the network) and monitor for the occurrence of a trigger, and if the trigger is identified to have occurred, the electronic device 101 may perform the post-camp-on operation (e.g., RA procedure, establishment of RRC association, and/or attachment to the network), and there is no limitation on the time of the monitoring of the trigger as described above.

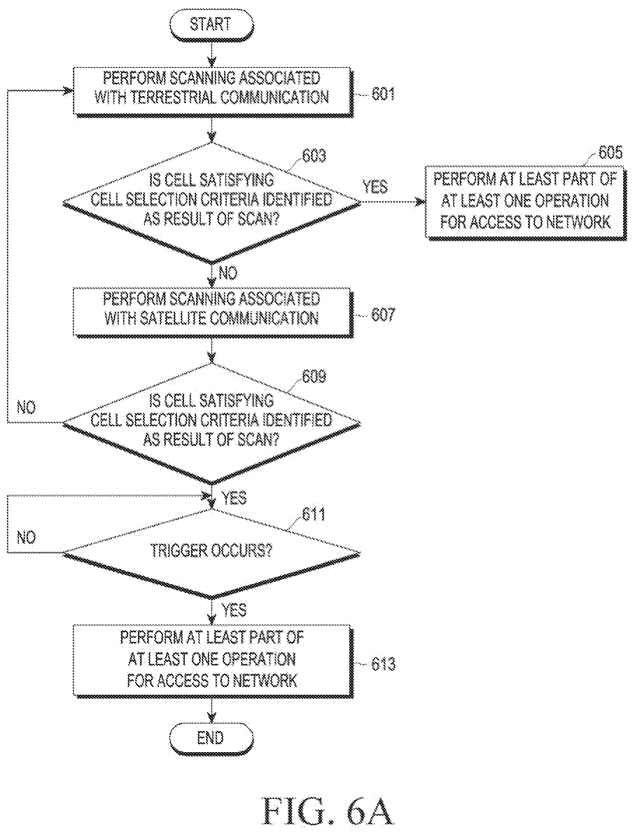

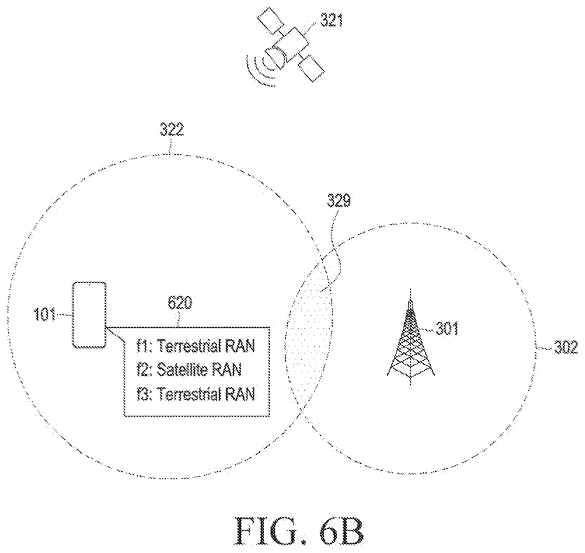

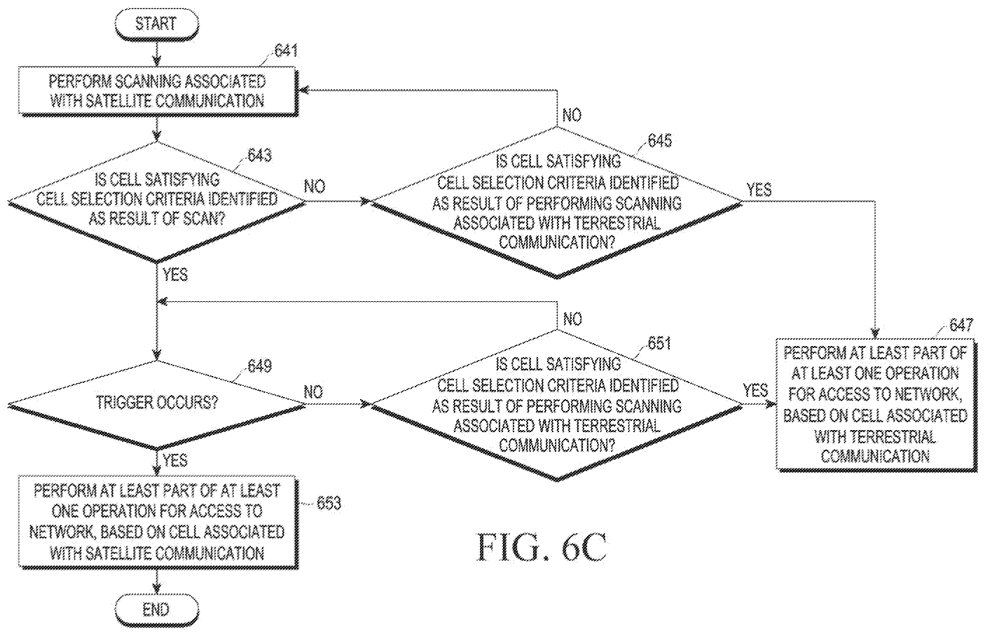

FIG. 6A is a flowchart illustrating an operation method of an electronic device according to an embodiment. FIG. 6A will be described with reference to FIG. 6B. FIG. 6B illustrates scanning of an electronic device according to an embodiment.

According to an embodiment, the electronic device 101 (e.g., the processor 120, the first communication processor 212, the second communication processor 214, and/or the integrated communication processor 260) may perform scanning associated with terrestrial communication in operation 601. For example, the electronic device 101 may store information capable of identifying satellite communication, as described above, thereby allowing the electronic device 101 to distinguish between terrestrial communication and satellite communication. For example, the electronic device 101 may pre-store information 620 associated with a cell, as shown in FIG. 6B. The information 620 is illustrated as including a frequency, for example, as information associated with terrestrial and/or satellite communication, but this is an example and the type of information 620 is not limited. For example, the electronic device 101 may perform scanning associated with terrestrial communication based on a PLMN and/or frequency corresponding to the terrestrial communication. For example, in the example of FIG. 6B, the electronic device 101 may preferentially perform scanning for the frequencies of F1 and F3 associated with terrestrial communication than for the frequencies of F2 associated with satellite communication. In operation 603, the electronic device 101 may identify whether a cell that satisfies the cell selection criteria is identified as a result of the scanning. If a cell satisfying the cell selection criteria is identified (“yes” in operation 603), the electronic device 101 may perform at least part of the at least one operation for access to the network, in operation 605. For example, in case that a cell associated with terrestrial communication is scanned, the electronic device 101 may immediately perform all of the operations for accessing. If a cell satisfying the cell selection criteria is not identified (“no” in operation 603), the electronic device 101 may perform scanning associated with satellite communication in operation 607. For example, the electronic device 101 may perform scanning associated with terrestrial communication based on a PLMN and/or frequency corresponding to the satellite communication. In operation 609, the electronic device 101 may identify whether a cell that satisfies the cell selection criteria is identified as a result of the scanning. For example, the cell selection criteria may be configured differently for satellite communication and terrestrial communication, but are not limited thereto. In case that a cell associated with satellite communication is not identified (“no” in operation 609), the electronic device 101 may perform scanning associated with terrestrial communication in operation 601, but this is an example and the electronic device 101 may be configured to repeatedly perform scanning associated with satellite communication. If a cell associated with satellite communication is identified (“yes” in operation 609), the electronic device 101 may identify whether a trigger occurs, in operation 611. In case that the trigger does not occur (“no” in operation 611), the electronic device 101 may continue to monitor whether the trigger occurs. In case that the trigger has occurred (“yes” in operation 611), the electronic device 101 may perform at least part of the at least one operation for access to the network, based on a cell associated with satellite communication, in operation 613. As described above, the electronic device 101 may be configured to preferentially camp on a cell associated with terrestrial communication than satellite communication, thereby preventing the electronic device from accessing satellite communication even though accessing terrestrial communication is possible.

FIG. 6C is a flowchart illustrating an operation method of an electronic device according to an embodiment.

According to an embodiment, the electronic device 101 (e.g., the processor 120, the first communication processor 212, the second communication processor 214, and/or the integrated communication processor 260) may perform scanning associated with terrestrial communication in operation 641. In operation 643, the electronic device 101 may identify whether a cell that satisfies the cell selection criteria is identified as a result of the scanning. If a cell satisfying the cell selection criteria is not identified (“no” in operation 643), the electronic device 101 may identify whether a cell that satisfies the cell selection criteria is identified as a result of performing scanning associated with terrestrial communication, in operation 645. If a cell that satisfies the cell selection criteria and is associated with terrestrial communication is identified (“yes” in operation 645), the electronic device 101 may camp on a cell associated with terrestrial communication in operation 653. If a cell that is associated with satellite communication and satisfies the cell selection criteria is identified (“yes” in operation 643), the electronic device 101 may identify whether a trigger for the satellite communication occurs in operation 649. As described above, the electronic device 101 may monitor whether a trigger has occurred after camping on the corresponding cell, or may monitor whether a trigger has occurred without camping on the corresponding cell, and there is no limitation on the time of the monitoring.

In case that the trigger has not occurred, the electronic device 101 may suspend performing at least part of the at least one operation for access to the network, as described above. In case that the trigger has not occurred (“no” in operation 649), the electronic device 101 may perform scanning associated with terrestrial communication and identify whether a cell that satisfies the cell selection criteria is identified as a result of performing the scanning, in operation 651. If a cell that is associated with terrestrial communication and satisfies the cell selection criteria is identified (“yes” in operation 651), the electronic device 101 may perform at least part of the at least one operation for access to the network, based on the cell associated with terrestrial communication, in operation 647. If a cell that is associated with terrestrial communication and satisfies the cell selection criteria is not identified (“no” in operation 651), the electronic device 101 may identify whether a trigger occurs in operation 649. In case that the terrestrial communication is available even before the trigger occurs, the electronic device 101 may perform at least part of the at least one operation for access to the network, based on the cell associated with terrestrial communication. In case that the trigger occurs (“yes” in operation 649), the electronic device 101 may perform at least part of the at least one operation for access to the network, based on the cell associated with satellite communication, in operation 653.

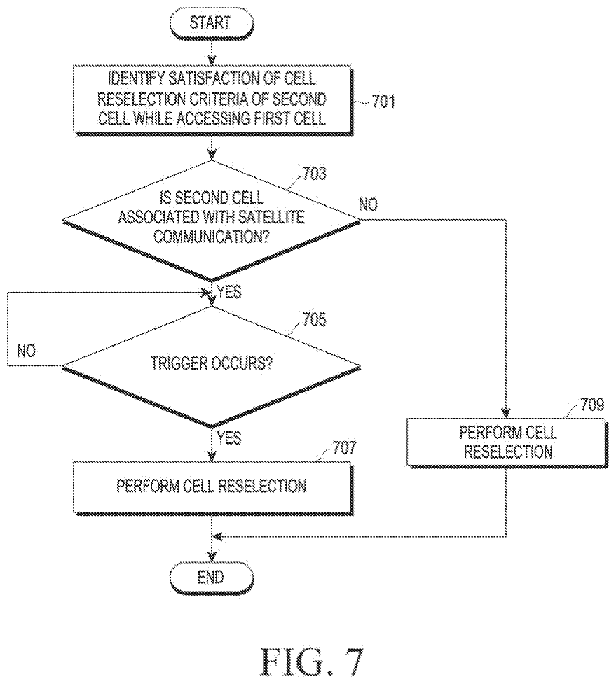

FIG. 7 is a flowchart illustrating an operation method of an electronic device according to an embodiment.

According to an embodiment, the electronic device 101 (e.g., the processor 120, the first communication processor 212, the second communication processor 214, and/or the integrated communication processor 260) may, in operation 701, while accessing a first cell, identify satisfaction of a cell reselection criteria of a second cell. Based on the identification of satisfaction of the cell reselection criteria, the electronic device 101 may identify whether the second cell is associated with satellite communication in operation 703. For example, the same PLMN may be assigned to the terrestrial communication and the satellite communication. In case that a cell is associated with satellite communication, the electronic device 101 may not immediately perform cell reselection based on satisfaction of the cell reselection criteria, but may suspend cell reselection until a trigger occurs. In case that the second cell is not associated with satellite communication (“no” in operation 703), the electronic device 101 may perform cell reselection by camping on the second cell associated with terrestrial communication, in operation 709. In case that the second cell is associated with satellite communication (“yes” in operation 703), the electronic device 101 may suspend cell reselection and monitor whether a trigger occurs in operation 705. In case that the trigger does not occur (“no” in operation 705), the electronic device 101 may continue monitoring for the occurrence of the trigger. In case that the trigger occurs (“yes” in operation 705), the electronic device 101 may perform cell reselection, by camping on the second cell associated with satellite communication, in operation 707. On the other hand, in case that the occurrence of the trigger is not identified, the electronic device 101 may enter a no-service state while maintaining cell reselection, for example. In this case, the electronic device 101 may be configured to suspend performing at least part of the at least one operation for access to the network, based on the second cell, and then perform at least part of the at least one operation for access to the network, based on the second cell based on the identification of the occurrence of the trigger described above. Alternatively, the electronic device 101 may be configured to perform re-scanning based on disconnecting from the first cell, and there is no limitation thereto. As described above, the electronic device 101 may not immediately reselect the cell associated with satellite communication upon satisfaction of the cell reselection criteria, but may suspend cell reselection and then perform cell reselection based on the occurrence of a trigger.

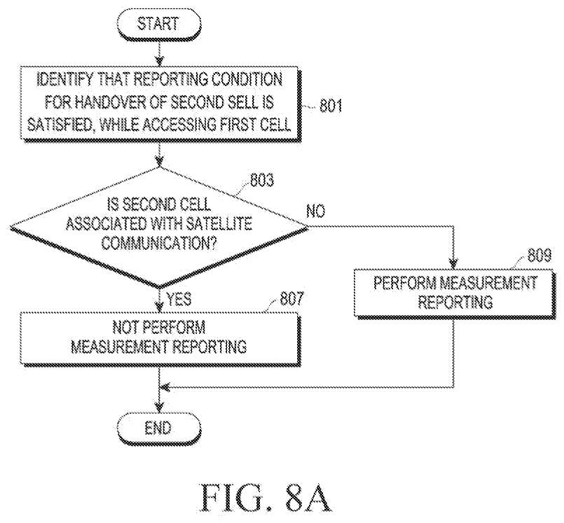

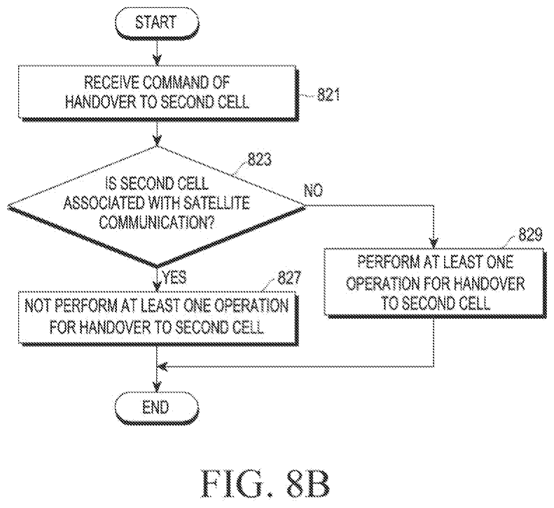

FIG. 8A is a flowchart illustrating an operation method of an electronic device according to an embodiment.

According to an embodiment, the electronic device 101 (e.g., the processor 120, the first communication processor 212, the second communication processor 214, and/or the integrated communication processor 260) may, in operation 801, while accessing a first cell, identify that a reporting condition for a handover of a second cell is satisfied. For example, the electronic device 101 may receive, from the first cell, an RRC reconfiguration message including a measurement object (MO) for the second cell. The electronic device 101 may perform a measurement on the second cell based on the MO, and may identify that the measurement result for the second cell satisfies a reporting condition (e.g., may be a B1 event, but is not limited thereto). The electronic device 101 may identify whether the second cell is associated with satellite communication, in operation 803. In case that the second cell is not associated with satellite communication (“no” in operation 803), the electronic device 101 may perform measurement reporting for the second cell in operation 809. Thereafter, if a command of handover to the second cell is received from a network, the electronic device 101 may perform a handover to the second cell. In case that the second cell is associated with satellite communication (“yes” in operation 803), the electronic device 101 may not perform measurement reporting in operation 807. It will be understood by those skilled in the art that not performing the measurement reporting here may mean, for example, that the electronic device 101 does not perform measurement reporting despite satisfaction of the measurement reporting condition, and may be implemented by instructions such as operation 807, or may be implemented by instructions such as a conditional statement in which measurement reporting is not performed in the case of being associated with satellite communication.

FIG. 8B is a flowchart illustrating an operation method of an electronic device according to an embodiment.

According to an embodiment, the electronic device 101 (e.g., the processor 120, the first communication processor 212, the second communication processor 214, and/or the integrated communication processor 260) may, in operation 821, while accessing a first cell, receive a command of handover to a second cell. For example, the electronic device 101 may receive, from the first cell, an RRC reconfiguration message including a measurement object (MO) for the second cell. The electronic device 101 may perform a measurement on the second cell based on the MO, and may identify that the measurement result on the second cell satisfies a reporting condition (e.g., may be a B1 event, but is not limited thereto). The electronic device 101 may perform measurement reporting for the second cell based on the satisfaction of a reporting condition. The electronic device 101 may receive a command of handover to the second cell from a network in response to the measurement reporting. The electronic device 101 may identify whether the second cell is associated with satellite communication, in operation 823. In case that the second cell is not associated with satellite communication (“no” in operation 823), the electronic device 101 may perform at least one operation for handover to the second cell in operation 829. For example, the electronic device 101 may perform an RA procedure, an RRC connection establishment procedure, and/or a TAU procedure to the second cell, but there is no limitation. In case that the second cell is associated with satellite communication (“yes” in operation 823), the electronic device 101 may not perform the at least one operation for handover in operation 827. It will be understood by those skilled in the art that not performing the at least one operation for handover may mean, for example, that the electronic device 101 does not perform an operation for handover (e.g., an RA procedure) despite receiving a handover command, and may be implemented by an instruction such as in operation 827, or may be implemented by an instruction such as a conditional statement in which a handover command is not performed in the case of being associated with satellite communication.

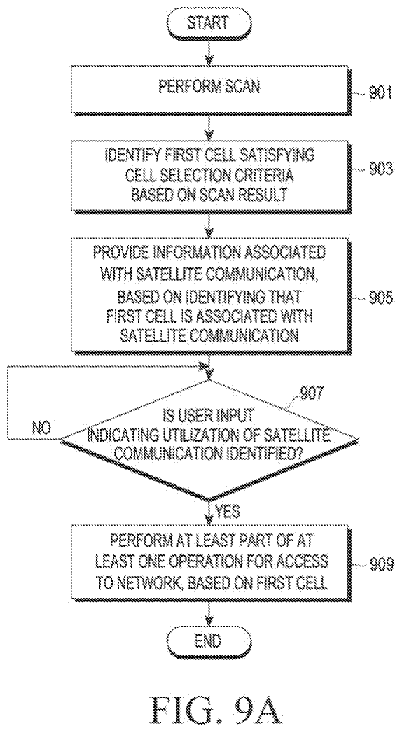

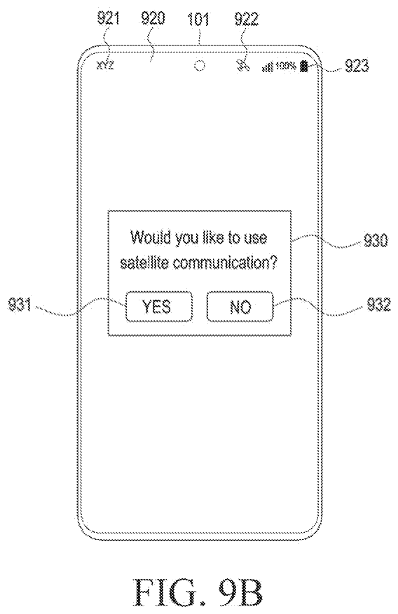

FIG. 9A is a flowchart illustrating an operation method of an electronic device according to an embodiment. The embodiment of FIG. 9A will be described with reference to FIG. 9B. FIG. 9B illustrates a screen displayed on an electronic device according to an embodiment.

According to an embodiment, the electronic device 101 (e.g., the processor 120, the first communication processor 212, the second communication processor 214, and/or the integrated communication processor 260) may perform scanning in operation 901. For example, the electronic device 101 may perform scanning based on stored information. For example, the electronic device 101 may preferentially perform scanning for terrestrial communication than for satellite communication, but this is an example and there are no limitations on the priorities. In operation 903, the electronic device 101 may identify a first cell that satisfies the cell selection criteria based on a result of the scanning. In operation 905, the electronic device 101 may provide information associated with satellite communication based on the identification that the first cell is associated with satellite communication. For example, as shown in FIG. 9B, the electronic device 101 may display an indicator 922 indicating that scanning for satellite communication has been performed. For example, the electronic device 101 may display the indicator 922 indicating that the satellite communication has been scanned before camping on the first cell, or before performing network registration after camping on the first cell, and the timing of the display is not limited. The indicator 922 indicating that satellite communication has been scanned may be located in an indication area 920 in which, for example, mobile network operator identification information 921 and battery level 923 are displayed, but this is an example and there are no limitations on its shape and/or display location. The electronic device 101 may display a message 930 inquiring access to satellite communication. The message 930 may include, but is not limited thereto, text indicating that satellite communication are available, a button 931 to cause access, and/or a button 932 to disable access. For example, the designation of button 931 may cause the electronic device 101 to access the satellite communication. The message 930 may be represented as part of a screen, or may be implemented as a pop-up window covering at least a part of an existing displayed screen, but there is no limitation thereto. The indicator 922 and the message 930 may be displayed simultaneously, or only one of them may be displayed. For example, it may be implemented such that only the indicator 922 is displayed, and then the message 930 is displayed in response to a user operation.

According to an embodiment, the electronic device 101 may identify, as the occurrence or not of the trigger, whether a user input indicating utilization of the satellite communication is identified, in operation 907. If the user input indicating utilization of the satellite communication is not identified (“no” in operation 907), the electronic device 101 may continue monitoring whether a user input occurs or not. In case that the user input indicating utilization of the satellite communication is identified (“yes” in operation 907), the electronic device 101 may perform at least part of at least one operation for registration to the network, based on the first cell, in operation 909. For example, the electronic device 101 may perform, based on the designation of the button 931 in FIG. 9B, at least part of the at least one operation for registration to the network, based on the first cell. Accordingly, the electronic device 101 may not access the satellite communication when the user does not require communication, and the electronic device 101 may access the satellite communication only when the user requires communication.

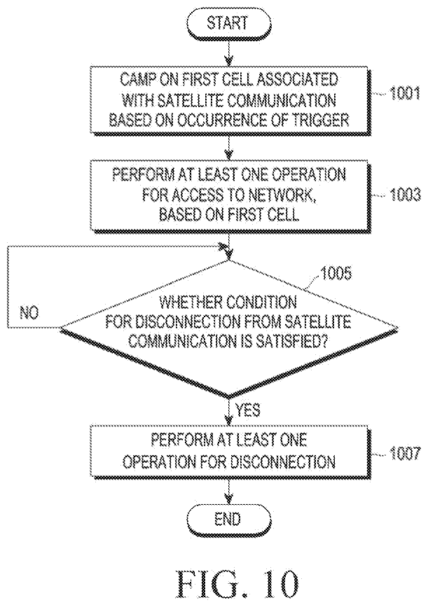

FIG. 10 is a flowchart illustrating an operation method of an electronic device according to an embodiment.

According to an embodiment, the electronic device 101 (e.g., the processor 120, the first communication processor 212, the second communication processor 214, and/or the integrated communication processor 260) may camp on a first cell associated with satellite communication based on the occurrence of a trigger, in operation 1001. The electronic device 101 may perform at least one operation for access based on the first cell, in operation 1003. In operation 1005, the electronic device 101 may identify whether a condition for disconnection from the satellite communication is satisfied. In case that the condition for disconnection is satisfied (“yes” in operation 1005), the electronic device 101 may perform at least one operation for disconnection in operation 1007. The electronic device 101 may perform the disconnection relatively early, thereby reducing the number of terminals accessing the satellite communication. For example, in the case of an emergency service, continuous communication with an emergency center may be desired, and thus paging reception (or, paging monitoring) may be used. For example, the electronic device 101 may identify completion of an emergency service as a disconnection condition and perform disconnection. In some cases, disconnection may not be performed in the case of an emergency service. Alternatively, the electronic device 101 may perform disconnection by identifying a user's termination command as a disconnection condition. Disconnection may include, but is not limited thereto, detaching, disconnecting, and/or declaring an RLF from the core network. For example, in the case of an SMS service, the electronic device 101 may remain in an access state for a predetermined period of time after sending an SMS, so as to receive a reply. The electronic device 101 may perform disconnection by identifying the passage of a predetermined period of time after sending the SMS as a condition for disconnection. Alternatively, the electronic device 101 may be configured to remain in an access state after satellite communication is initiated until it is out of coverage of the satellite communication. Alternatively, the electronic device 101 may provide a user with a UI inquiring whether to maintain accessing the satellite communication, and may also perform disconnection based on receiving a disconnection command through the UI.

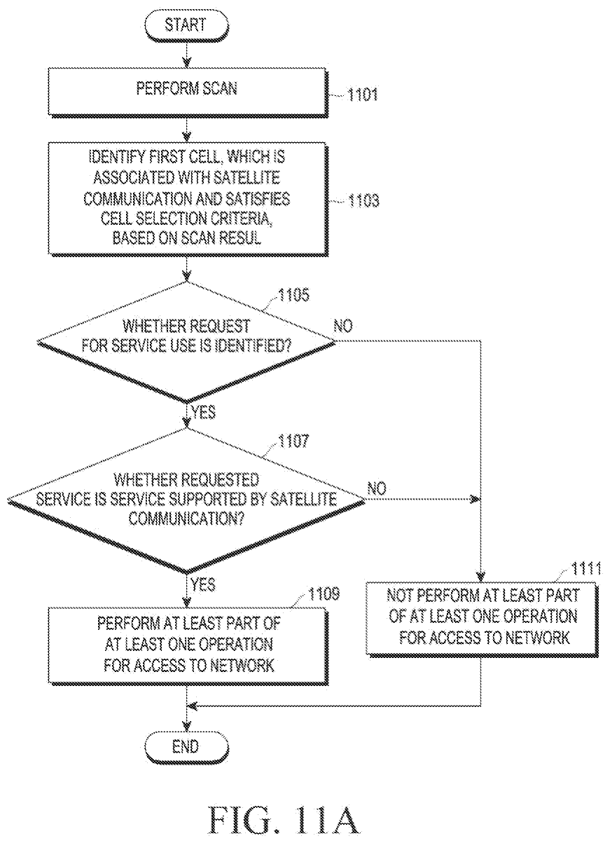

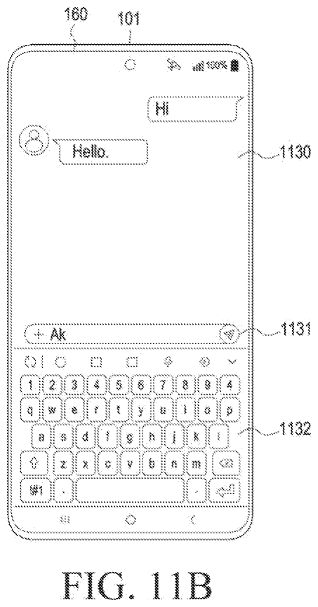

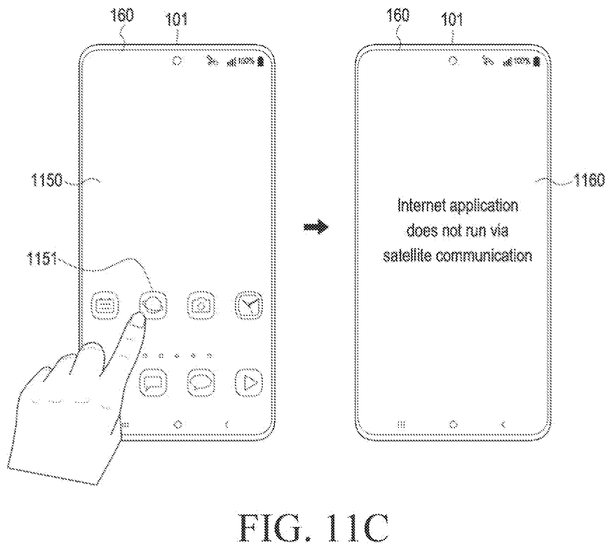

FIG. 11A is a flowchart illustrating an operation method of an electronic device according to an embodiment. The embodiment of FIG. 11A will be described with reference to FIGS. 11B and 11C. FIGS. 11B and 11C illustrate a screen displayed on an electronic device according to an embodiment.

According to an embodiment, the electronic device 101 (e.g., the processor 120, the first communication processor 212, the second communication processor 214, and/or the integrated communication processor 260) may perform scanning in operation 1101. For example, the electronic device 101 may perform scanning based on stored information. For example, the electronic device 101 may preferentially perform scanning for terrestrial communication than for satellite communication, but this is an example and there is no limitation on the priorities. In operation 1103, the electronic device 101 may identify a first cell that is associated with satellite communication and satisfies the cell selection criteria, based on a result of the scanning. In operation 1105, the electronic device 101 may identify whether a request for service use is identified. For example, the electronic device 101 may identify whether the request for service use is identified before camping on the first cell, or before performing network registration after camping on the first cell, and there is no limitation on the time of the identification. In case that the request for service use is not identified (“no” in operation 1105), the electronic device 101 may not perform at least part of the at least one operation for registration to the network, based on the first cell in operation 1111. For example, as shown in FIG. 11B, the electronic device 101 may execute a messenger application to display an execution screen 1130 of the messenger application. The execution screen 1130 may include a text display window 1131 and a soft input panel (SIP) 1132. In at least one example, the electronic device 101 may recognize, as a request for service use, input from the text display window 1131 based on input of one of keys on the SIP 1132. Alternatively, in another example, the electronic device 101 may identify a call of the SIP 1132 as a request for service use. Alternatively, in another example, the electronic device 101 may identify the execution of a messenger application (or other application) as a request for service use. As described above, the request for service use may be implemented in various ways and is not limited thereto.

In case that the request for service use is identified (“yes” in operation 1105), the electronic device 101 may identify whether the requested service is a service supported by the satellite communication, in operation 1107. In case that the requested service is not a service supported by the satellite communication (“no” in operation 1107), the electronic device 101 may not perform at least part of the at least one operation for registration to the network, based on the first cell, in operation 1111. In case that the requested service is a service supported by satellite communication (“yes” in operation 1107), the electronic device 101 may perform at least part of the at least one operation for registration to the network, based on the first cell, in operation 1109. For example, referring to FIG. 11C, the electronic device 101 may display an execution screen 1150 of a launcher application, and may identify, as a request for service use, a designation of a web browsing application icon 1151 included in the execution screen 1150. The electronic device 101 may identify whether the requested service is supported by satellite communication. Services supported by satellite communication may be stored in the electronic device 101 at the time of manufacture, subsequently downloaded from a server, and/or received through a network, for example, and there are no restrictions on the method of acquisition. For example, data communication for a web browsing application may not be supported by satellite communication. In this case, the electronic device 101 may not perform at least part of the at least one operation for registration to a network corresponding to satellite communication, and may, for example, display a screen 1160 (or a pop-up window) explaining that the requested service is not available by satellite communication, as shown in FIG. 11C. In at least one example, the electronic device 101 may display a screen explaining that the requested service is partially limited by satellite communication.

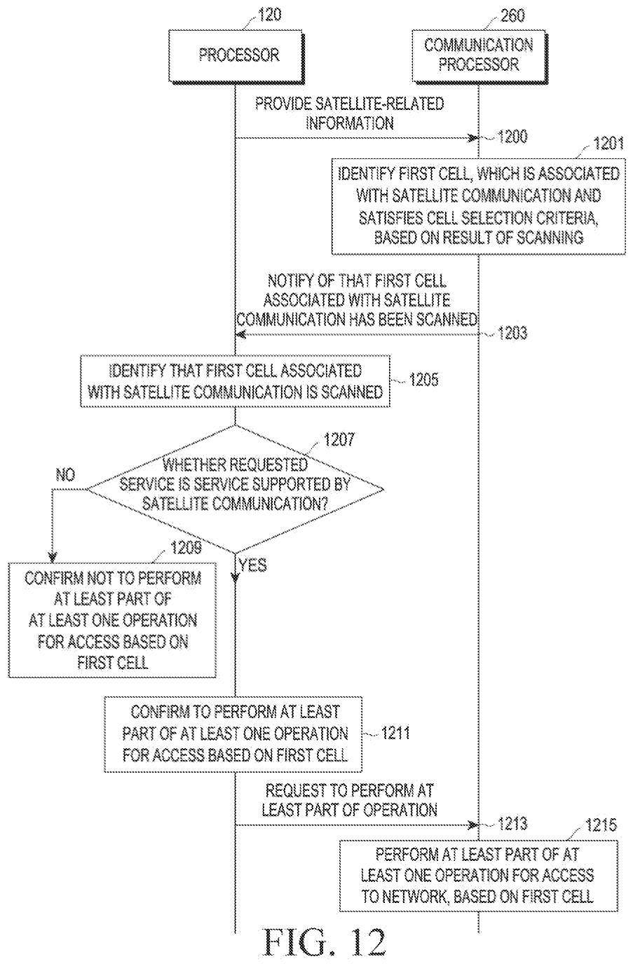

FIG. 12 is a flowchart illustrating an operation method of a processor and a communication processor according to an embodiment.

According to an embodiment, the processor 120 may provide satellite-related information to a communication processor 260 (or the first communication processor 212 and/or the second communication processor 214) in operation 1200. Alternatively, the communication processor 260 may manage the satellite-related information, and there is no limitation on the management entity. In this case, the communication processor 260 may notify the processor 120 of information indicating that a first cell that is associated with satellite communication and satisfies the cell selection criteria has been identified. In operation 1201, the communication processor 260 may identify the first cell, which is associated with satellite communication and satisfies the cell selection criteria, based on a result of the scanning. The communication processor 260 may, for example, perform scanning based on satellite-related information (e.g., PLMN and/or frequency) provided by the processor 120 to identify that the first cell is associated with a satellite communication, but there is no limitation thereon. Further, the communication processor 260 may, for example, identify that the first cell is associated with satellite communication based on information from a network (e.g., system information) without information from the processor 120. The communication processor 260 may notify the processor 120 that the first cell associated with satellite communication has been scanned, in operation 1203. For example, the electronic device 101 may provide a message including an identifier indicating the satellite communication to the processor 120, but there is no limitation on the notification method. The communication processor 260 may suspend performing at least part of at least one operation for access to the network, based on the first cell, since it is before the occurrence of the trigger. In operation 1205, the processor 120 may identify that the first cell currently associated with satellite communication is in a scanned state.

According to an embodiment, the processor 120 may identify whether the requested service is a service supported by the satellite communication, in operation 1207. As described above, the processor 120 may identify a service that is supported by the satellite communication, and may identify whether the requested service is a service supported by the satellite communication. On the other hand, the communication processor 260 may request the processor 120 to identify whether the requested service is satellite-supported, and in response thereto, the processor 120 may be implemented to identify whether the currently requested service is a satellite-supported service and provide the same to the communication processor 260, and there are no restrictions on the entity identifying whether the service is supported by satellite communication. In case that the requested service is not a service supported by satellite communication (“no” in operation 1207), the processor 120 may confirm not to perform at least part of the at least one operation for access to the network, based on the first cell, in operation 1209. In this case, the processor 120 may not transmit a request for network use to the communication processor 260. In case that the requested service is a service supported by satellite communication (“yes” in operation 1207), the processor 120 may confirm to perform at least part of the at least one operation for access to the network, based on the first cell, in operation 1211. The processor 120 may request the communication processor 260 to perform at least part of the at least one operation for access to the network, based on the first cell, in operation 1213. The communication processor 260 may, based on reception of the request, perform at least part of the at least one operation for access to the network, based on the first cell, in operation 1215. Accordingly, the communication processor 260 may access a satellite, and may transmit and receive data based on the requested service. For example, in case that the requested service is SMS, the communication processor 260 may transmit data for SMS based on SMS over NAS method. Alternatively, in case that the requested service is SMS, the communication processor 260 may establish a PDN connection (or, a PDU session in the case of 5G) of the IMS and transmit the same, and there is no limitation on the transmission method. For example, in case that the requested service is an emergency call and satellite communication supports the service, the communication processor 260 may establish a PDN connection of the IMS and transmit the same. For example, in case that the requested service is data communication and satellite communication supports the service, the communication processor 260 may establish a PDN connection of the Internet and transmit the same.

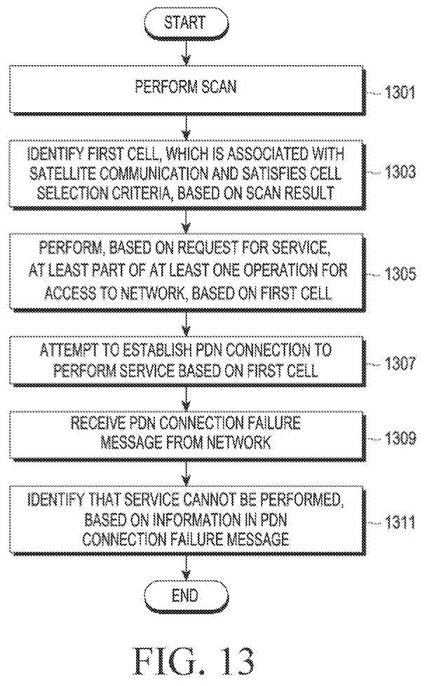

FIG. 13 is a flowchart illustrating an operation method of an electronic device according to an embodiment.

According to an embodiment, the electronic device 101 (e.g., the processor 120, the first communication processor 212, the second communication processor 214, and/or the integrated communication processor 260) may perform scanning in operation 1301. For example, the electronic device 101 may perform scanning based on stored information. For example, the electronic device 101 may preferentially perform scanning for terrestrial communication than for satellite communication, but this is an example and there is no limitation on the priorities. In operation 1303, the electronic device 101 may identify a first cell, which is associated with satellite communication and satisfies the cell selection criteria, based on a result of the scanning. The electronic device 101 may, based on a request for service, perform at least part of the at least one operation for access to the network, based on the first cell, in operation 1305. As described above, the electronic device 101 may identify the service request before camping on the first cell, or before accessing a network after camping on the first cell, and there is no limitation on the time of the identification. In operation 1307, the electronic device 101 may attempt to establish a PDN connection to perform a service based on the first cell. For example, the electronic device 101 may attempt to establish a PDN connection (or, in the case of 5G, a PDU session of a DNN corresponding to the requested service) of an APN corresponding to the requested service (or application). The network may reject the request for service that is not supported by satellite communication. The electronic device 101 may receive a PDN connection failure message from the network in operation 1309. Based on the information in the PDN connection failure message, the electronic device 101 may identify that the service is unable to be performed. The electronic device 101 may not attempt to access if the same service request is identified when the satellite is subsequently scanned.

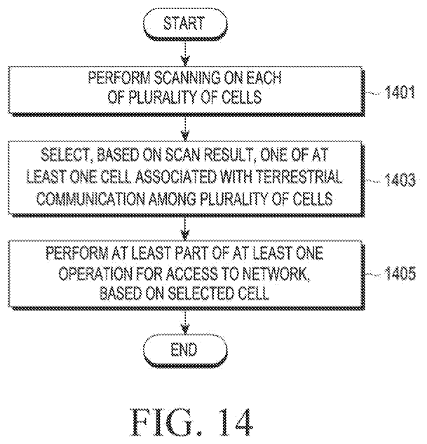

FIG. 14 is a flowchart illustrating an operation method of an electronic device according to an embodiment.

According to an embodiment, the electronic device 101 (e.g., the processor 120, the first communication processor 212, the second communication processor 214, and/or the integrated communication processor 260) may perform scanning on each of a plurality of cells in operation 1401. Each of the plurality of cells may include a cell associated with terrestrial communication and a cell associated with satellite communication. The electronic device 101 may perform scanning based on stored information, for example, but there is no limitation on a scanning method. In operation 1403, the electronic device 101 may select, based on a result of the scanning, one of at least one cell associated with terrestrial communication among a plurality of cells. For example, as a result of the scanning, both cells associated with terrestrial communication and cells associated with satellite communication may be identified. In this case, the electronic device 101 may preferentially select a cell associated with terrestrial communication. In operation 1405, the electronic device 101 may camp on the selected cell and perform at least one operation to access the network. As described above, the electronic device 101 may first camp on the cell associated with terrestrial communication, and if camping on the cell associated with terrestrial communication has failed, the electronic device may subsequently camp on a cell associated with satellite communication.

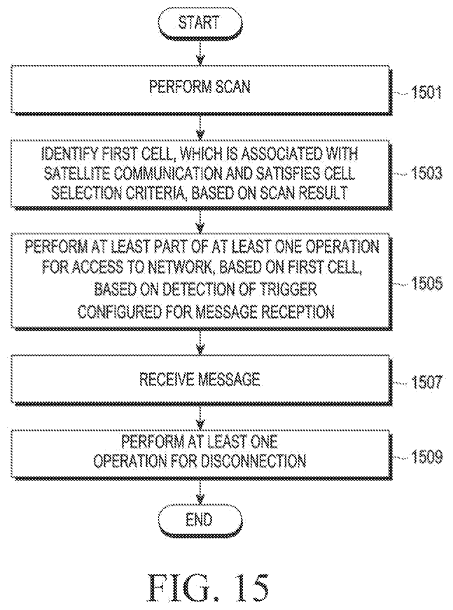

FIG. 15 is a flowchart illustrating an operation method of an electronic device according to an embodiment.

According to an embodiment, the electronic device 101 (e.g., the processor 120, the first communication processor 212, the second communication processor 214, and/or the integrated communication processor 260) may perform scanning in operation 1501. In operation 1503, the electronic device 101 may identify a first cell, which is associated with satellite communication and satisfies the cell selection criteria, based on a result of the scanning. In operation 1505, the electronic device 101 may perform at least part of at least one operation for access to the network, based on the first cell, based on detection of a trigger configured for message reception. As described above, identifying of the trigger configured for monitoring may be performed before camping-on the first cell, or before network access after camping-on the first cell, and there is no limitation thereon. For example, the electronic device 101 should identify whether a message for which the electronic device 101 is a recipient exists in, for example, an SMS. As at least one example, the electronic device 101 may detect the expiration of a designated timer as a trigger configured for monitoring, and camp on the first cell. For example, the expiration time of a timer may be preconfigured, or may be adjusted based on a user input. For example, the electronic device 101 may provide a UI for adjusting the expiration time of a timer. The UI may include, for example, a visual object for adjusting a message reception period based on satellite communication, but there is no limitation on the implementation method thereof. The UI may be supported by a message application or an application for satellite communication control, and there is no limitation thereon. In case that the corresponding function may be deactivated based on a user input, the electronic device 101 may not perform temporary access or disconnection. The electronic device 101 may receive a message for which the electronic device 101 is a recipient in operation 1507. In case that a message exists, the electronic device 101 may receive and provide the message. Thereafter, the electronic device 101 may perform at least one operation for disconnection in operation 1509. In case that the message does not exist, the electronic device 101 may, instead of operation 1507, wait for a message and perform at least one operation for disconnection. For example, after disconnection is completed, the electronic device 101 may start a timer again, thereby periodically performing temporary access and disconnection operations to receive a message for which the electronic device 101 is the recipient. Meanwhile, those skilled in the art will understand that in addition to timer-based periodic temporary access and disconnection operations, event-based (e.g., execution of a messenger application) temporary access and disconnection operations may be performed.

According to an embodiment, an electronic device 101 may include memory 130 storing instructions, at least one processor 120, 212, 214, and 260, and RF circuits 222, 224, 228, 232, and 234. The instructions, when executed by at least one processor 120, 212, 214, 260, may cause the electronic device 101 to perform scanning by using the RF circuits 222, 224, 228, 232, and 234 in a state in which the electronic device 101 has not accessed a network. The instructions, when executed by at least one processor 120, 212, 214, 260, may cause the electronic device 101 to, based on a result of the performing of the scanning, identify a first cell located around the electronic device 101. The instructions, when executed by at least one processor 120, 212, 214, 260, may cause the electronic device 101 to, based on identifying that the first cell is associated with satellite communication, monitor whether a trigger requiring a connection to satellite communication has occurred or not. The instructions, when executed by at least one processor 120, 212, 214, 260, may cause the electronic device 101 to, based on that the occurrence of the trigger is identified according to the monitoring, perform at least part of the at least one operation for access to the network, based on the first cell.

According to an embodiment, The instructions, when executed by at least one processor 120, 212, 214, 260, may cause the electronic device 101 to, based on failing to identify the occurrence of the trigger, continue monitoring for the trigger while suspending performance of at least part of the at least one operation for access to the network, based on the first cell.

According to an embodiment, The instructions, when executed by at least one processor 120, 212, 214, 260, may cause the electronic device 101 to, based on information provided from the first cell, identify whether the first cell is associated with satellite communication.

According to an embodiment, The instructions, when executed by at least one processor 120, 212, 214, 260, may cause the electronic device 101 to, after having accessed the first cell, monitor whether a disconnection condition is satisfied. The instructions, when executed by at least one processor 120, 212, 214, 260, may cause the electronic device 101 to perform at least one operation for disconnection from the first cell, based on identifying satisfaction of the disconnection condition as a result of the monitoring.

According to an embodiment, The instructions, when executed by at least one processor 120, 212, 214, 260, may cause the electronic device 101 to, based on the result of performing the scanning, identify a second cell located around the electronic device 101. The instructions, when executed by at least one processor 120, 212, 214, 260, may cause the electronic device 101 to, based on identifying that the second cell is associated with terrestrial communication, perform at least part of the at least one operation for access to the network, based on the second cell.

According to an embodiment, The instructions, when executed by at least one processor 120, 212, 214, 260, may cause the electronic device 101 to identify the first cell as being associated with satellite communication, based on a frequency and/or PLMN of the first cell corresponding to at least a part of at least one frequency and/or at least one PLMN corresponding to satellite communication.

According to an embodiment, The instructions, when executed by at least one processor 120, 212, 214, 260, may cause the electronic device 101 to, as at least part of an operation of performing the scanning, perform at least one first scan for terrestrial communication. The instructions, when executed by at least one processor 120, 212, 214, 260, may cause the electronic device 101 to, as at least part of the operation of performing the scanning, perform at least one second scan for satellite communication based on a failure of scanning of a cell associated with terrestrial communication according to a result of performing the at least one first scan.

According to an embodiment, The instructions, when executed by at least one processor 120, 212, 214, 260, may cause the electronic device 101 to, after scanning the first cell associated with satellite communication based on the at least one second scan, perform at least one third scan for terrestrial communication before the trigger occurs.

According to an embodiment, The instructions, when executed by at least one processor 120, 212, 214, 260, may cause the electronic device 101 to, based on that the occurrence of the trigger is identified, as at least part of performing at least part of at least one operation for access to the network, based on the first cell, camp on the first cell based on identifying, as the occurrence of the trigger, a user input causing use of the satellite communication.

According to an embodiment, The instructions, when executed by at least one processor 120, 212, 214, 260, may cause the electronic device 101 to, based on that the occurrence of the trigger is identified, identify a request for use of a first service, as at least part of performing at least part of at least one operation for access to the network, based on the first cell. The instructions, when executed by at least one processor 120, 212, 214, 260, may cause the electronic device 101 to, as at least part of the operation of camping on the first cell based on identifying the occurrence of the trigger, perform at least part of at least one operation for access to the network, based on the first cell, based on identifying, as the occurrence of the trigger, that the first service is supported by satellite communication.

According to an embodiment, The instructions, when executed by at least one processor 120, 212, 214, 260, may cause the electronic device 101 to camp on and access the first cell, based on detection of another trigger for receiving a message, after scanning the first cell associated with satellite communication and before the occurrence of the trigger. The instructions, when executed by at least one processor 120, 212, 214, 260, may cause the electronic device 101 to receive or wait for a message for which the electronic device 101 is a recipient. The instructions, when executed by at least one processor 120, 212, 214, 260, may cause the electronic device 101 to disconnect from the first cell after the receiving or waiting for the message.

According to an embodiment, an operation method of an electronic device (101), the operation method may comprise performing scanning in a state in which the electronic device 101 has not accessed a network. The operation method may comprise identifying a first cell located around the electronic device 101, based on a result of the performing of the scanning. The operation method may comprise monitoring whether a trigger requiring a connection to satellite communication has occurred or not, based on identifying that the first cell is associated with satellite communication. The operation method may comprise performing at least part of at least one operation for access to the network, based on the first cell, based on that the occurrence of the trigger is identified according to the monitoring.

According to an embodiment, The operation method may comprise continuing, based on failing to identify the occurrence of the trigger, monitoring for the trigger while suspending performance of at least part of the at least one operation for access to the network, based on the first cell.

According to an embodiment, The operation method may comprise identifying, based on information provided from the first cell, whether the first cell is associated with satellite communication.

According to an embodiment, The operation method may comprise, after having accessed the first cell, monitoring whether a disconnection condition is satisfied. The operation method may comprise performing at least one (disconnection) operation for disconnection from the first cell, based on identifying satisfaction of the disconnection condition as a result of the monitoring.

According to an embodiment, The operation method may comprise identifying, based on the result of performing the scanning, a second cell located around the electronic device 101. The operation method may comprise performing, based on identifying that the second cell is associated with terrestrial communication, at least part of at least one (second access) operation for access to the network, based on the second cell.

According to an embodiment, The operation method may comprise identifying the first cell as being associated with satellite communication, based on a frequency and/or PLMN of the first cell corresponding to at least a part of at least one frequency and/or at least one PLMN corresponding to satellite communication.

According to an embodiment, the performing of the scanning may include performing at least one first scan for terrestrial communication. The performing of the scanning may include performing at least one second scan for satellite communication, based on a failure of scanning of a cell associated with terrestrial communication, according to a result of performing the at least one first scan.

According to an embodiment, The operation method may comprise camping on and accessing the first cell associated with satellite communication, based on detection of another trigger for receiving a message, after scanning the first cell and before the occurrence of the trigger. The operation method may comprise receiving or waiting for a message for which the electronic device 101 is a recipient. The operation method may comprise, after the receiving or waiting for the message, disconnecting from the first cell.

According to an embodiment, a non-transitory computer readable medium 130 storing instructions may be configured to, when executed by at least one processor 120, 212, 214, 260 of an electronic device 101, cause the electronic device 101 to perform scanning in a state in which the electronic device (101) has not accessed a network. A non-transitory computer readable medium 130 storing instructions may be configured to, when executed by at least one processor 120, 212, 214, 260 of an electronic device 101, cause the electronic device 101 to, based on a result of the performing of the scanning, identify a first cell located around the electronic device 101. A non-transitory computer readable medium 130 storing instructions may be configured to, when executed by at least one processor 120, 212, 214, 260 of an electronic device 101, cause the electronic device 101 to, based on identifying that the first cell is associated with satellite communication, monitor whether a trigger requiring a connection to satellite communication has occurred or not. A non-transitory computer readable medium 130 storing instructions may be configured to, when executed by at least one processor 120, 212, 214, 260 of an electronic device 101, cause the electronic device 101 to, based on that the occurrence of the trigger is identified according to the monitoring, perform at least part of at least one (first access) operation for access to the network, based on the first cell.

According to an embodiment, the electronic device 101 may include (at least one) memory (130) storing instructions, at least one processor 120, 212, 214, and 260, and RF circuits 222, 224, 228, 232, and 234. The at least one processor is connected to the memory, the at least one processor being configured to execute the instructions to cause the electronic device 101 to perform scanning by using the RF circuits 222, 224, 228, 232, and 234 in a state in which the electronic device 101 has not accessed a network. The instructions may be configured to, when executed by the at least one processor 120, 212, 214, and 260, cause the electronic device 101 to, based on a result of the performing of the scanning, identify a first cell located around the electronic device 101. The instructions may be configured to, when executed by the at least one processor 120, 212, 214, and 260, cause the electronic device 101 to, based on the first cell being associated with terrestrial communication, perform at least part of at least one operation for access to the network, based on the first cell. The instructions may be configured to, when executed by the at least one processor 120, 212, 214, and 260, cause the electronic device 101 to suspend camping on the first cell, based on the first cell being associated with satellite communication.

According to an embodiment, a non-transitory computer readable medium 130 storing instructions may be configured to, when executed by at least one processor 120, 212, 214 and 260 of an electronic device 101, cause the electronic device 101 to perform scanning in a state in which the electronic device 101 has not accessed a network. A non-transitory computer readable medium 130 storing instructions may be configured to, when executed by at least one processor 120, 212, 214 and 260 of an electronic device 101, cause the electronic device 101 to identify a first cell located around the electronic device 101, based on a result of the performing of the scanning. A non-transitory computer readable medium 130 storing instructions may be configured to, when executed by at least one processor 120, 212, 214 and 260 of an electronic device 101, cause the electronic device 101 to perform at least part of at least one operation for access to the network, based on the first cell, based on the first cell being associated with terrestrial communication. A non-transitory computer readable medium 130 storing instructions may be configured to, when executed by at least one processor 120, 212, 214 and 260 of an electronic device 101, cause the electronic device 101 to suspend camping-on the first cell, based on the first cell being associated with satellite communication.

According to an embodiment, the operation method of the electronic device 101 may include performing scanning in a state in which the electronic device 101 has not accessed a network. The operation method of the electronic device 101 may include identifying a first cell located around the electronic device 101, based on a result of the performing of the scanning. The operation method of the electronic device 101 may include performing at least part of at least one operation for access to the network, based on the first cell, based on the first cell being associated with terrestrial communication. The operation method of the electronic device 101 may include suspending performing at least part of the at least one operation for access to the network, based on the first cell, based on the first cell being associated with satellite communication.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a radio frequency (RF) circuit;
memory storing instructions; and
at least one processor operatively connected to the memory, the at least one processor being configured to execute the instructions to cause the electronic device to:
perform scanning, by using the RF circuit, in a state that the electronic device has not accessed a network;
based on a result of the scanning, identify a first cell located around the electronic device;
based on identifying that the first cell is associated with satellite communication, monitor whether a trigger requiring a connection to the satellite communication occurs; and
based on identifying an occurrence of the trigger, perform at least one first access operation for access to the network based on the first cell.

2. The electronic device of claim 1, wherein the at least one processor is configured to execute the instructions to cause the electronic device to, based on failing to identify the occurrence of the trigger, continue monitoring for the trigger while postponing performance of the at least one first access operation.

3. The electronic device of claim 1, wherein the at least one processor is configured to execute the instructions to cause the electronic device to identify, based on information provided from the first cell, whether the first cell is associated with the satellite communication.

4. The electronic device of claim 1, wherein the at least one processor is configured to execute the instructions to cause the electronic device to:
after having accessed the first cell, monitor whether a disconnection condition is satisfied; and
based on identifying the disconnection condition is satisfied, perform at least one disconnection operation for disconnection from the first cell.

5. The electronic device of claim 1, wherein the at least one processor is configured to execute the instructions to cause the electronic device to:
based on the result of the scanning, identify a second cell located around the electronic device; and
based on identifying that the second cell is associated with terrestrial communication, perform at least one second access operation for access to the network based on the second cell.

6. The electronic device of claim 1, wherein the at least one processor is configured to execute the instructions to cause the electronic device to identify the first cell as associated with the satellite communication, based on the first cell having a frequency and/or Public Land Mobile Network (PLMN) of the satellite communication.

7. The electronic device of claim 1, wherein the at least one processor is configured to execute the instructions to cause the electronic device to:
perform at least one first scan for terrestrial communication; and
based on a failure of the at least one first scan, perform at least one second scan for the satellite communication.

8. The electronic device of claim 7, wherein the at least one processor is configured to execute the instructions to cause the electronic device to, after performing the at least one second scan of the first cell associated with the satellite communication, perform at least one third scan for the terrestrial communication before the occurrence of the trigger.

9. The electronic device of claim 1, wherein the at least one processor is configured to execute the instructions to cause the electronic device to:
based on identifying a user input causing use of the satellite communication as the occurrence of the trigger, perform the at least one first access operation.

10. The electronic device of claim 1, wherein the at least one processor is configured to execute the instructions to cause the electronic device to:
identify a request for use of a first service; and
based on identifying that the first service is supported by the satellite communication as the occurrence of the trigger, perform the at least one first access operation.

11. The electronic device of claim 1, wherein the at least one processor is configured to execute the instructions to cause the electronic device to:
after scanning the first cell associated with the satellite communication, and before the occurrence of the trigger, camp on and access the first cell, based on detection of another trigger for receiving a message;
receive or wait for the message for which the electronic device is a recipient; and
disconnect from the first cell after the receiving or waiting for the message.

12. An operation method of an electronic device, the operation method comprising:
performing scanning in a state that the electronic device has not accessed a network;
based on a result of the scanning, identifying a first cell located around the electronic device;
based on identifying that the first cell is associated with satellite communication, monitoring whether a trigger requiring a connection to the satellite communication occurs; and
based on identifying an occurrence of the trigger, performing at least one first access operation for access to the network based on the first cell.

13. The operation method of claim 12, further comprising:
based on failing to identify the occurrence of the trigger, continuing monitoring for the trigger while postponing performance of the at least one first access operation.

14. The operation method of claim 12, further comprising:
based on information provided from the first cell, identifying whether the first cell is associated with the satellite communication.

15. The operation method of claim 12, further comprising:
after having accessed the first cell, monitoring whether a disconnection condition is satisfied; and
based on identifying the disconnection condition is satisfied, performing at least one disconnection operation for disconnection from the first cell.

16. The operation method of claim 12, further comprising:
based on the result of the scanning, identifying a second cell located around the electronic device; and
based on identifying that the second cell is associated with terrestrial communication, performing at least one second access operation for access to the network based on the second cell.

17. The operation method of claim 12, further comprising: identifying the first cell as associated with the satellite communication, based on the first cell having a frequency and/or Public Land Mobile Network (PLMN) of the satellite communication.

18. The operation method of claim 12, further comprising:
performing at least one first scan for terrestrial communication; and
based on a failure of the at least one first scan, performing at least one second scan for the satellite communication.

19. The operation method of claim 12, further comprising:
after scanning the first cell associated with the satellite communication, and before the occurrence of the trigger, camping on and accessing the first cell based on detection of another trigger for receiving a message;
receiving or waiting for the message for which the electronic device is a recipient; and
after the receiving or waiting for the message, disconnecting from the first cell.

20. A non-transitory computer readable medium storing instructions configured to, when executed by at least one processor of an electronic device, cause the electronic device to:
perform scanning in a state that the electronic device has not accessed a network;
based on a result of the scanning, identify a first cell located around the electronic device;
based on identifying that the first cell is associated with satellite communication, monitor whether a trigger requiring a connection to the satellite communication occurs; and
based on identifying an occurrence of the trigger, perform at least one first access operation for access to the network based on the first cell.
